(19) United States
(12) Patent Application Publication
(10) Pub. No.: US 2015/0347987 A1
(43) Pub. Date: Dec. 3, 2015

(54) Integrated Daily Digital Planner

(71) Applicant: Zainul Abedin Ali, Coppell, TX (US)

(72) Inventor: Zainul Abedin Ali, Coppell, TX (US)

(21) Appl. No.: 14/292,432

(22) Filed: May 30, 2014

(51) Int. Cl. G06Q 10/10; G06F 17/30

(52) U.S. Cl. CPC G06Q 10/1097; G06F 17/30867; G06F 17/3053

(57) ABSTRACT

A system and method for an integrated daily digital planner is provided. A computing device generates a homepage associated with a daily digital planner. The homepage includes a plurality of modular components. A calendar modular component displays a set of entries associated with a selected date within a calendar pane. Each entry identifies a task or event. A notes modular component displays a set of notes created on the selected date in a daily notes pane. A tasks modular component displays a set of tasks associated with the selected date in the tasks pane. The tasks modular component tracks a status of each task in a current set of tasks scheduled to occur on the current date. A task status comprises an in progress task status, a deleted task status, a delegated task status, an assigned task status, a forwarded task status, and a no action task status.

### 1. FIELD OF THE INVENTION

The system and method generally relate to information management, and more particularly, to a daily digital planner implemented on a computing device to assist a user in managing and prioritizing information, calendar, tasks, notes, time, and expenses from a strategic to execution level.

### 2. BACKGROUND ART

The management of both personal and business calendars, tasks, expenses, goals, contacts, activities, and to-do items remains a daily chore for most individuals and businesses. Traditional paper bound day planners, journals, notebooks, and diaries may be used to keep track of time and expenses (hereinafter “T&E”), tasks, and other information. Paper calendars can be hung on a wall or placed on desk to keep track of appointments and events. A person may also use hand written paper lists and sticky notes as reminders of tasks and appointments. However, these traditional paper methods are time consuming, inefficient, cumbersome, and limited.

Currently, smart phones with digital calendars and multiple point mobile applications are taking the place of paper bound day planners, notebooks, and diaries by allowing users to enter their individual schedules, upcoming important events, and reminders into their mobile phone, or other mobile device. However, the existing individual applications for calendar, contacts, T&E, and notes lack integration and ease of use. For example, with presently available applications on a user's mobile phone, reminders, alerts, calendar entries, notes, and contacts are all entered into various separate locations on the mobile phone.

Thus, there are various components that may be included on one's mobile phone, tablet, or computer, that provide specific, narrow functions, but these items do not work together as a whole. These components are not ideal for assisting a user to efficiently manage his or her information. Furthermore, mobile devices, such as cellular phones and computational tablets, are not equipped with a central data organizing application that adequately assists users to manage their life on a daily basis.

The ability to create goals at the strategic level and then break them into manageable components for execution is important and useful for both individuals and companies striving to achieve business objectives. Corporations continue to work on systems and methods for integrating the goals and mission of the company into the work force. However, the current techniques and methods are still lacking and inadequate for individuals to execute on a daily basis. This problem of goal realization and efficient time prioritization has not been translated, thus far, into the digital applications and mechanisms available in the marketplace today. Thus, there still exists a need for an improved time management, task scheduling, record-keeping system that is accessible to users on multiple computing devices. Similarly, the ability to gather items such as expenses or miles on a daily basis and then consolidate them to provide monthly or other periodic views on multiple computing devices is not available.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed to a daily digital planner by which a more optimal system and method for information management is presented. In one aspect, the daily digital planner provides for an integrated digital calendar, a daily notes component, and a tasks component. In another embodiment, the daily digital planner provides for an integrated digital calendar, daily notes component, tasks component, and a plurality of data organization components, such as, but without limitation, a time and expense component, an expense summary component, a journal, an e-Card management component, a lists component, a goals management components, and a leadership development component. The daily digital planner organizes data relevant to a user, including providing a checklist and also a set of tasks to associate with a digital calendar. Further, a module for a user's contacts is also provided as part of the daily digital planner.

In one aspect of the daily digital planner, a module is presented to the user for storing pertinent goals and priorities of the user. The module provides for a series of sub-goals to make them more manageable and each sub-goal can have tasks to be associated with the achievement of the goals and priorities. The daily digital planner allows for each task to be executed by integrating the task associated with the sub-goal to be scheduled on a prioritized daily task list, such that when tasks are executed on a daily basis, all supporting sub-goals and goals are met at the strategic level leading users to view their progress and ultimately meet their goals.

In another aspect of the daily digital planner, the user has the ability create customized lists from a predefined list, which is specific to an event, such as a grocery list for shopping. The customized list can be scheduled as a task on the digital daily planner. A customized list can also be further shared or delegated to other users who also have access to the daily digital planner and are in a network connected to a primary user of the daily digital planner.

In another aspect, the daily digital planner synchronizes the daily digital planner's digital calendar with one or more other calendaring applications associated with the user of the daily digital planner. The user continues using the one or more other calendaring applications on the user's computing device. The daily digital planner synchronizes the one or more other calendaring applications with the digital daily planner's digital calendar to create a common hub for sharing the digital daily planner's digital calendar with other networked users of the digital daily planner.

### BRIEF DESCRIPTION OF THE DRAWINGS

The disclosure will provide details in the following description of preferred embodiments with reference to the following figures wherein:

FIG. 1 is a block diagram of a daily digital planner in accordance with one embodiment;

FIG. 2 is a block diagram of another daily digital planner in accordance with one embodiment;

FIG. 3 is a pictorial illustration of a homepage for a daily digital planner in accordance with one embodiment;

FIG. 4 is a pictorial illustration of a home page for a daily digital planner having a time and expenses pane in accordance with one embodiment;

FIG. 5 is a pictorial illustration of an add task field associated with a tasks modular component of a daily digital planner in accordance with one embodiment;

FIG. 6 is a pictorial illustration of a task list associated with a tasks modular component of a daily digital planner in accordance with one embodiment;

FIG. 7 is a pictorial illustration of an expenses search result associated with an expenses modular component of a daily digital planner in accordance with one embodiment;

FIG. 8 is a pictorial illustration of a master lists page generated by a checklist modular component of a daily digital planner in accordance with one embodiment;

FIG. 9 is a pictorial illustration of a customized checklist associated with a checklist modular component of a daily digital planner in accordance with one embodiment;

FIG. 10 is a pictorial illustration of a goals management pane associated with a goals modular component of a daily digital planner in accordance with one embodiment;

FIG. 11 is a pictorial illustration of a leadership pane associated with a leadership modular component of a daily digital planner in accordance with one embodiment;

FIG. 12 is a pictorial illustration of journal categories associated with a journal modular component of a daily digital planner in accordance with one embodiment;

FIG. 13 is a pictorial illustration of a create e-Card pane associated with an e-Card modular component in accordance with one embodiment;

FIG. 14 is a flowchart of a process for a daily digital planner having a plurality of modular components in accordance with one embodiment;

FIG. 15 is a flowchart of a process for a lists modular component in accordance with one embodiment;

FIG. 16 is a pictorial illustration of is a pictorial illustration depicting an embodiment of a network environment in accordance with an illustrative embodiment in accordance with one embodiment; and

FIG. 17 is a pictorial illustration of a data processing system in which embodiments may be implemented.

### DETAILED DESCRIPTION OF THE DRAWINGS

For purposes of reading the description of the various embodiments below, the following descriptions of the sections of the specification and their respective content may be helpful: Section A describes embodiments of systems and methods for an information management and goal achievement system utilizing a daily digital planner, as described below. Section B describes a network environment and computing environment which may be useful for practicing embodiments described herein.

### A: Daily Digital Planner

The following description provides for one or more embodiments of a daily digital planner of one embodiment, which receives data from one or more users and assists in organizing and compartmentalizing the data in a central and integrated daily digital planner to assist the user in planning daily activities and implementing specific goals and priorities. It should be understood that any of the examples described herein are non-limiting examples. As such, the present embodiments, aspects, concepts, structures, functionalities, or examples described herein are non-limiting, and the present invention may be used in various ways that provide benefits and advantages in assisting a user through information management and data organization in general.

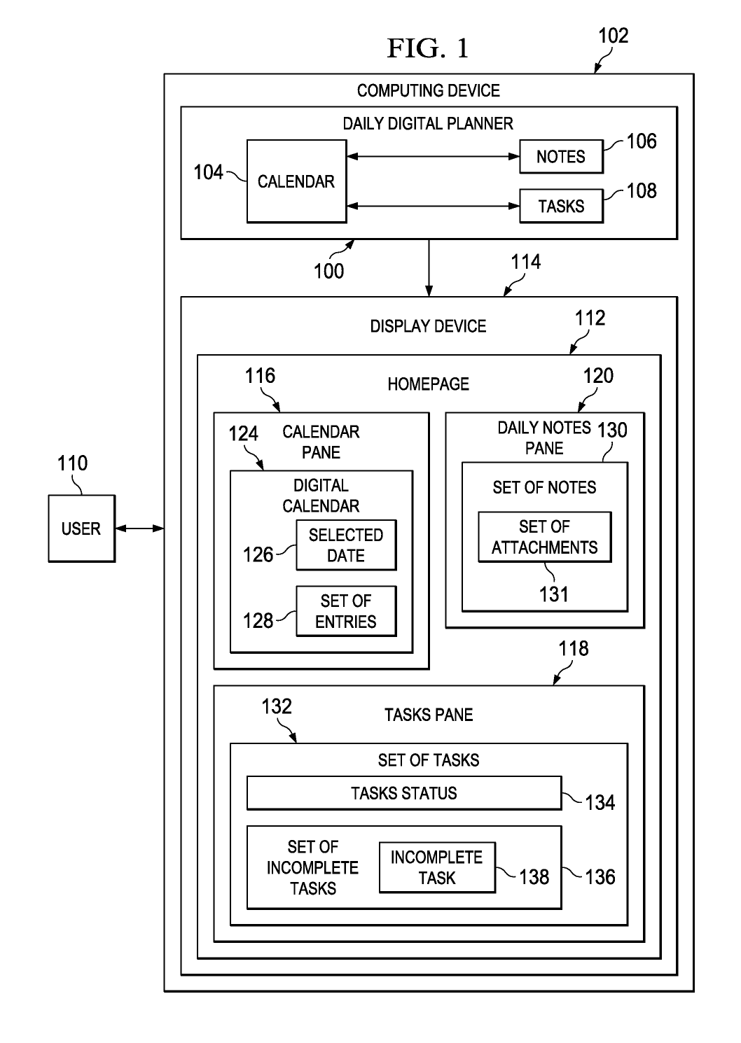

FIG. 1 is a block diagram depicting a non-limiting embodiment of an integrated daily digital planner in accordance with one or more embodiments of the presently claimed invention. Daily digital planner 100 is a digital planner that receives data from one or more users and assists in organizing and managing the data. Daily digital planner 100 provides a central management application in the format of a digital planner that comprises a plurality of modules for managing a daily calendar, prioritized tasks, notes, time, expenses, goals, leadership development, lists, and other daily task related information. Daily digital planner 100 is capable of managing diverse types of personal, family, and work related data, such as, but not limited to, meetings, appointments, events, schedules, contacts, tasks, checklists, daily notes, time and expenses, goals, membership information, insurance information, reward card information, and journal entries into a single, integrated, digital daily planner.

In this example, daily digital planner 100 is a software application executing on a computing device 102. In other words, User 110 accesses daily digital planner 100 via computing device 102.

Computing device 102 may be implemented as any type of computing device, such as, but without limitation, a desktop computer, a laptop computer, a tablet computer, a personal digital assistant (PDA), a smart phone, a smart watch, or a wearable computer with optical head mounted display, such as, but without limitation, Google Glass®, as well as any other type of computing device. Computing device 202 may be a mobile or non-mobile computing device. The term “mobile” refers to a computing device that is quickly and easily transportable. A mobile computing device includes, without limitation, mobile phones, also referred to as cellular phones or smart phones, laptops, and tablet computers. A non-mobile computing device is a computing device, such as, but without limitation, desktop computers that are not regularly transported or typically carried around by the associated users.

Computing device 102 includes many components known to one of ordinary skill in the art, including, but not limited, to a user interface for user 110 to enter in relevant data into daily digital planner 100. A user interface may comprise, without limitation, a keyboard. The keyboard may be connected to computing device 102 through a cable or wire. The keyboard may also be connected via Bluetooth or a Wi-Fi Internet connection. Such a keyboard may be a touch screen simulated keyboard that is included with various smart phones, tablets, and computers. By utilizing the user interface associated with computing device 102, user 110 is capable of entering data in daily digital planner 100.

Daily digital planner 100 is an electronic planner leveraging a plurality of information management modular components, such as calendar 104, notes 106, and tasks 108, to provide a single application for managing all of a user's daily information management needs. Calendar 104, notes 106, and tasks 108 are integrated modular components working together to manage schedules, appointments, events, tasks, activities, notes, lists, contacts, and other information relevant to user 110.

Daily digital planner 100 generates a homepage 112 on display device 114 associated with computing device 102. Display device 114 is a screen capable of generating an image. Display device 114 may be implemented as a computer monitor, a touch screen, a liquid crystal display (LCD) screen, a plasma screen, mobile phone display screen, an optical head mounted display, or any other type of device capable of generating homepage 112. In this embodiment, homepage 112 includes calendar pane 116, task pane 118, and daily notes pane 120.

Calendar 104 component manages digital calendar 124. Digital calendar 124 is an electronic calendar. Digital calendar 124 displays selected date 126 and a set of entries 128 associated with selected date 126 in the calendar pane 116. Selected date 126 may be today's current date, a date in the past, or a date in the future. Calendar 104 selects today's current date as a default selected date when user 110 has not chosen or otherwise selected a date.

Digital calendar 124 includes multiple calendar views. User 110 may select a day calendar view, a week calendar view, or a month calendar view. For example, a day calendar view displays only selected date 126. A month calendar view displays every day in a given month including selected date 126 in calendar pane 116

Digital calendar 124 is populated with set of entries 126. Set of entries 128 may include a single entry, two or more entries, as well as no entries. Each entry in set of entries 128 identifies or indicates an event or task scheduled to occur on one or more dates in digital calendar 124. In this embodiment, each entry in set of entries 128 identifies a task and/or event scheduled to occur on selected date 126.

An event may include, without limitation, a meeting, an appointment, a task to perform, a conference call, a webinar, an activity, or any other event. A task may be anything user 110 needs to accomplish, complete, acquire, or do. For example, a task may be a single activity to be completed, a single item to be purchased, or a list of items to be purchased and/or completed.

Thus, if selected date 126 is the current date, set of entries 128 identifies events and/or tasks scheduled for today's current date. If selected date 126 is a date in the past, set of entries 128 identifies events and/or tasks that were scheduled to occur or to be done on the selected past date. Likewise, if selected date 126 is a date in the future, set of entries 126 identifies events and/or tasks that are scheduled to occur or to be done on the future date.

Set of notes 130 includes all notes created on selected date 126. Set of notes 130 is displayed in daily notes pane 120. Set of notes 130 may include a single note, two or more notes, as well as no notes.

If selected date 126 is the current date, set of notes 130 includes all notes, if any, created today. If selected date 126 is a date in the past, set of notes 130 includes all notes, if any, created on the selected past date. However, if selected date 126 is a future date, daily notes pane 120 will be empty or unpopulated.

If user 110 selects a different date in digital calendar 116, the set of notes 130 displayed in daily notes pane 120 changes to the set of notes that were created on that different selected date. In other words, as user 110 selects new dates in digital calendar 116 to view, the notes displayed in daily notes pane 120 also changes to show the notes created on the newly selected date currently being displayed in digital calendar 124. Thus, notes in set of notes 130 are tied or linked to a date in digital calendar when the set of notes 130 were created.

Set of notes 130 may include set of attachments 131. Each attachment in set of attachments 131 is associated with a note in set of notes 130. Set of attachments 131 may include a single attachment associated with a single note, two or more attachments associated with a single note, two or more attachments associated with two or more different notes, as well as no attachments.

User 110 may add an attachment to any given note in set of notes 130. The attachment may include, without limitation, a document, a digital picture, a scanned image, a sound recording or other audio file, or any other type of attachment. For example, user 110 may attach a picture of a whiteboard created during a meeting to the note written by user 110 during the same meeting.

Thus, user 110 may create an attachment using a scanner, digital camera, a microphone, or optical character recognition (OCR). OCR allows for the conversion of printed text to machine-encoded or computer-readable text.

In another embodiment, user 110 may select one or more other users to receive a copy of a given note in set of notes 130. For example, user 110 may choose to distribute a selected note created during a meeting to a group of users identified as meeting attendees. The selected note and all attachments associated with the selected note, if any, is then transmitted to each user in the group of users identified as meeting attendees by notes 106 component.

Tasks 108 modular component manages tasks displayed in tasks pane 118. Tasks 108 presents set of tasks 132 in tasks pane 118. Each task in set of tasks is an individual task, activity, scheduled checklist, and/or activities associated with either personal or professional objectives and goals that are relevant to user 110. Set of tasks 132 includes task lists, tasks assigned by others, tasks delegated to others, tasks scheduled to occur or be completed on selected date 126, as well as uncompleted tasks that have not yet been scheduled to occur and/or be completed on a specific date.

Tasks 108 associates set of tasks 132 with a date in calendar 104. In other words, set of tasks 132 is tied or linked to a date in digital calendar 124. When selected date 126 is the current date, set of tasks 132 associated with the current date is displayed in tasks pane 118. If selected date 126 is a date in the past, set of tasks 132 includes all tasks as they existed on that selected date in the past. In other words, if user 110 selects a different date, then the set of tasks 132 displayed in tasks pane 118 changes to the set of tasks associated with that different selected date. In this manner, the data in calendar 104, notes 106, and tasks 108 is integrated and interconnected for more efficient management and organization of calendaring, notes, and tasks related information.

Tasks 108 modular component includes a prioritization system. The prioritization may be alphabetically and/or numerically arranged. Tasks 108 displays each task in set of tasks 132 in an order of priority. In this example, tasks 108 displays a task having a higher priority in tasks pane 118 prior to a task having a lower priority. If no priority is set for one or more tasks in set of tasks 132, tasks 108 displays the un-prioritized task in an order of date and time of task creation.

In this embodiment, tasks 108 tracks or monitors task status 134 associated with each task in set of tasks 132. Task status 134 for a given task 132 may include, for example, but without limitation, an in progress task status, a deleted task status, a delegated task status, an assigned task status, a forwarded task status, or a no action task status.

At a predetermined time, tasks component 108 identifies a set of incomplete tasks 136 in set of tasks 132. An incomplete task 138 is a task having an in progress task status, a delegated task status, or a no action task status at the predetermined time. The predetermined time is a time set by user 110 at an end of the day or end of the work day. If user 110 does not set a predetermined time, tasks 108 selects a default time as the predetermined time. For example, tasks 108 may use midnight as the default predetermined time at which set of incomplete tasks 136 is identified. In another embodiment, the default predetermined time may be 5:30 p.m., or any other time selected as a default predetermined time.

At the predetermined time, tasks 108 forwards set of incomplete tasks 136 to a predetermined future date on the digital calendar 116. In other words, each task in set of incomplete tasks 136 is added to a second set of tasks associated with the predetermined future date.

The predetermined future date may be any future date selected by user 110. The predetermined future date may also be a default date. In this embodiment, if user 110 does not select a future date to rescheduled set of incomplete tasks, tasks component 108 automatically forwards each task in set of incomplete tasks 136 to a the next day on digital calendar 124. In other words, incomplete tasks are added to the set of tasks scheduled to occur on the following date.

In another embodiment, the default date may be the next work day. In other words, set of incomplete tasks 136 identified on a Thursday are forwarded to the next day, Friday. However, set of incomplete tasks 136 identified by tasks 108 at an end of the day on Friday are forwarded to the next work day, which is Monday in this non-limiting example.

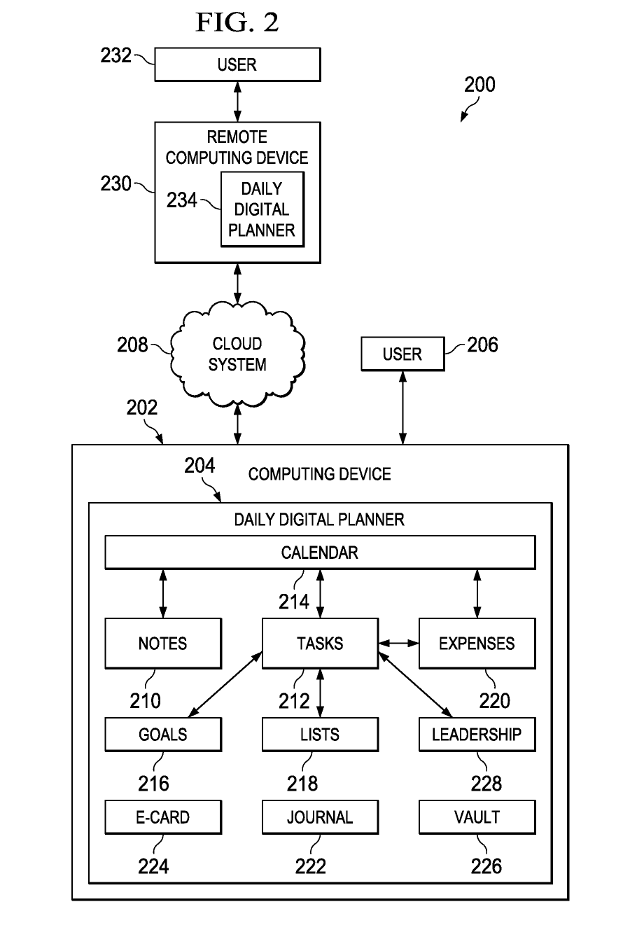

In this non-limiting embodiment, daily digital planner 100 is executing on computing device 102 without a network or internet connection. However, in another illustrative embodiment, computing device 102 may be connected to a network, internet, or cloud system, as shown in FIG. 2 below.

FIG. 2 is another block diagram depicting one or more non-limiting embodiments of another integrated daily digital planner in accordance with one or more embodiments of the presently claimed invention. Networked data processing system 200 is a data processing system that includes two or more computing devices, such as computing device 202, connected via a network and/or cloud system. Computing device 202 may be implemented as any type of computing device, such as, but without limitation, computing device 102 in FIG. 1 shown above. For example, computing device 202 may include, but is not limited to, such electronic products as smart phones, personal digital assistants (PDA), or tablet computers.

Daily digital planner 204 is an integrated daily planner for managing and organizing personal, family, and work related information, such as, daily digital planner 100 in FIG. 1. Daily digital planner 204 is a combination of modular components that are structured to provide access to the most relevant and useful pieces of data to assist user 206 in achieving his or her personal and professional goals, effectively manage time, and store pertinent information. In other words, daily digital planner 204 is a software module containing various sub-modules that allow a user to enter and organize relevant data to user 206. A module may be any type of software application configured to operate on computing device 202 and/or remote computing device 230, such as a mobile or non-mobile computing device. User 206 is a person with privileges and rights associated with daily digital planner 204 running on computing device 202.

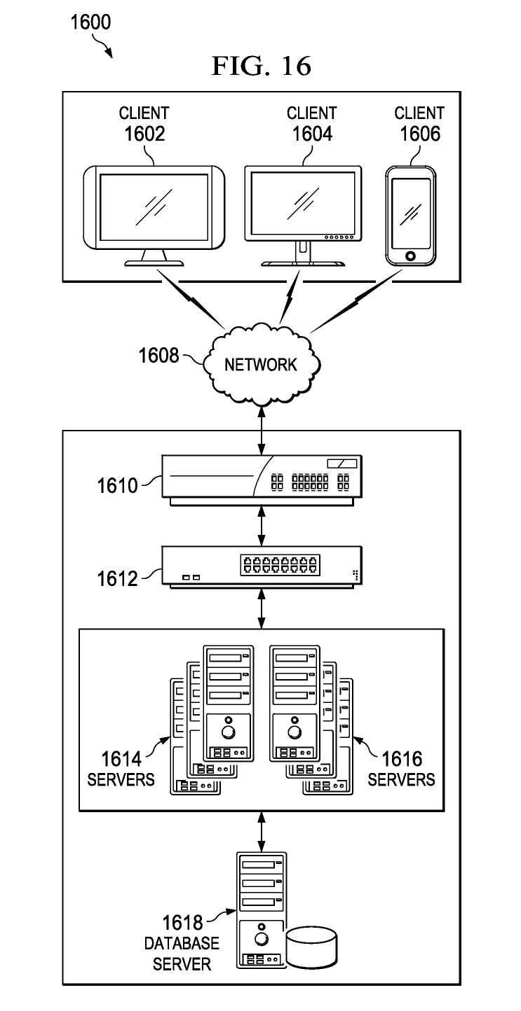

In this illustrative embodiment, computing device 202 is capable of connecting to cloud system 208 via the Internet. Cloud system 208 provides cloud service and cloud computing system. Cloud system 208 is a service that allows users, such as user 206, to sync and backup any information associated with daily digital planner 204 to one or more remote computer servers, such as, but without limitation, servers 1614-1618 in FIG. 16 below.

User 206 is able to backup data stored on computing device 202 to cloud system 208. Cloud system 208 also acts as a data syncing center for any data associated with the components located on daily digital planner 204. In one embodiment, cloud system 208 is configured to allow user 206 to wirelessly back up to a cloud storage system associated with cloud system 208 from any computing device associated with user 206.

Furthermore, cloud system 208 is configured to allow user 206 to download data associated with daily digital planner 204 to multiple devices associated with user 206, including mobile phones, laptop computers, desktop computers, and/or computer tablets associated with user 206. Ultimately, users associated with daily digital planner 204 are able to access daily digital planner 204 from multiple computing devices and access the same set of data from multiple computing devices as long daily digital planner 204 has been installed on these devices.

User 206 is also able to share data stored on daily digital planner 204 with another user selected from a group of networked users, such as user 232 accessing daily digital planner 234 on remote computing device 230. Remote computing device 230 may be implemented as any type of computing device. For example, but without limitation, remote computing device 230 may be a desktop computer, laptop computer, smart phone, table computer, or any other type of computing device capable of accessing daily digital planner 234 via cloud system 208.

In one embodiment, user 206 may share daily digital planner 204 data with user 232 and receive daily digital planner 204 data from user 232. For example, user 232 may send and receive data such as calendar dates, calendar entries, checklists, tasks, task lists, notes, expenses, expense summary reports, and contact information with multiple users in the group of networked users who have access to an integrated daily digital planner, such as digital planner 204 and/or daily digital planner 234, on their respective computing devices.

As a security measure, user 232 may be asked to provide an identifying pass code in order to send data to daily digital planner 204 and receive data from digital daily planner 204 associated with user 206. Thus, in one embodiment, data associated with daily digital planner 204 may be shared between multiple users who have sufficient rights and/or privileges to access daily digital planner 204.

Daily digital planner 204 may be downloaded via a network from the Internet or may be installed from a computer readable storage device onto a computing device associated with user 206. Daily digital planner 204 is configured to receive data from user 206 that is stored on computing device 202 in a set of components associated with daily digital planner 204.

Daily digital planner 204 shown in FIG. 2 includes a plurality of integrated modules. These modules include, without limitation, notes 210, tasks 212, calendar 214, goals 216, lists 218, expenses 220, journal 222, e-Card 224, vault 226, and leadership 228.

User 206 may enter data or employ features provided by one or more of these modules by either physically typing data into computing device 202, entering data using a touch screen, dictating using a voice-recognition component included in computing device 202, or any other known or available method for entering data into a computing device 202.

Notes 210, tasks 212, and calendar 214 are standard modules associated with a homepage for daily digital planner 204, such as homepage 112 shown in FIG. 1. The homepage appears to user 206 with integrated calendaring, task management, and notes management features provided by notes 210, calendar 214, and tasks 212 components.

Calendar 214 is a component creating and managing a digital calendar including months, dates, and years, such as digital calendar 124 in FIG. 1. Calendar 214 allows for user 206 to enter appointments, activities, schedule tasks and events of interest to user 206. Calendar 214 also provides reminders to user 206 of the entered appointments, activities, and upcoming scheduled tasks from tasks 212. A reminder may be an alert or a reminder. A reminder may be scheduled by user 206 either a few minutes, hours, days or week(s) before scheduled task or event. In another embodiment, Calendar 214 may be structured to automatically provide a reminder to user 206 a set number of minutes or hours prior to the scheduled event in Calendar 214.

In another embodiment, calendar 214 may be configured to sync the dates and items entered in Calendar 214 with other existing calendar modules already located on a computing device, such as computing device 202. Therefore, if a computing device, for example, is a smart phone with an existing calendar application, Calendar 214 may be configured to locate saved dates and data saved in calendar 214 in the other existing calendar system located on the user's smart phone.

In this embodiment, calendar 214 synchronizes the daily digital planner 204's digital calendar with one or more other calendaring applications associated with the user of daily digital planner 204. These other calendaring applications may be any calendar technology or calendar software, such as, but without limitation, Google calendar, Apple calendar, Microsoft calendar, or any other calendar application. Thus, daily digital planner 204 performs cross-platform syncing of the digital calendar with a set of other calendar applications associated with a plurality of different computer software platforms. Daily digital planner 204 updates the set of entries in the digital calendar with a second set of entries, wherein the second set of entries comprises events or tasks entered into the set of calendar applications.

The one or more other calendaring applications may be located on computing device 102 or accessed remotely via the Internet, cloud system 208, and/or other network connection. Thus, the user may continue scheduling events and entering contact information into the one or more other calendaring applications. Daily digital planner 202 synchronizes the one or more other calendaring applications with daily digital planner 204's digital calendar.

In another embodiment, one or more users in a set of networked users may access a group calendar view associated with the digital calendar of daily digital planner 202. The group calendar view is a portion of the digital calendar that has not been marked “private” by the primary user associated with daily digital planner 202. Thus, daily digital planner 204 synchronizes the digital calendar with the set of one or more other calendaring applications to create a common hub for sharing digital daily planner 204's group calendar view of the digital calendar with the set of networked users having privileges to view and/or access the group calendar view of digital daily planner 204.

Tasks 212 component is a module that presents to user 206 an electronic location in master planner 204 for recording and displaying tasks 212. Using the interactive screen and inputting components included in computing device 202, any task that user 206 does or needs to do in the future may be created and/or scheduled in tasks 212.

Tasks 212 is connected to calendar 214, goals 216, lists 218, and leadership 228. Tasks 212 tracks a status of each task to ensure each task is completed, forwarded, delegated, deleted, or otherwise in progress. Tasks 212 component maintains the task status for each task and updates the task status to reflect changes to the status.

User 206 enters a status update for one or more tasks associated with tasks 212. For example, if a task is completed by user 206, then user 206 designates “completed” for that entry. If a task has been delegated to another individual, then user 206 designates the task as “delegated.” If a task is in progress and needs to be carried over, then the user designates a selection in Tasks 212 included next to the Tasks 212 for “in progress” or “carry over.” If a user 206 designates a task as “in progress”, then master planner 204 will ask user to select a date over to which to carry and assign the task that is still in progress. Thus, user 206 may choose to select the next day to carry the task over or select another date and time. Additionally, a user may always select to delete a task from the list associated with Tasks 212 without selecting any of the designations, “completed”, “delegated,” or “in progress” as described above.

Furthermore, in one embodiment, tasks 212 also provides for a method and system for organizing and prioritizing each task associated with tasks 212. In one embodiment, the prioritization method associated with tasks 212 is configured to include both an alphabetical and numerical structuring system. The alphabetical and numerical structuring system presents a hierarchy of importance for assigning a priority to each task associated with tasks 212.

In one embodiment, the alphabetical and numerical structuring system is composed of a series of letters, starting with the letters “A” to “D”. The letter “A” is associated with the most important or pressing matters as determined by user 206. The letter “D” is the least important task as determined by user 206. Furthermore, user 206 may select numbers 1-10 for also indicating a level of importance of each task as determined by user 206. Thus, the alphabetical and numerical organization and prioritization method and system allows user 206 to prioritize each task associated with tasks 212.

Typically, people have a list of activities and tasks that they would ideally like to achieve during a single day. In addition, there are those set of activities that absolutely must be completed in a person's day. The method and system, as described herein, gives user 206 a format for entering in their tasks and activities into tasks 212 and lists 218 so as to delegate a level of importance to each activity. Thus, tasks 212 component offers to user 206 a means for electronically recording scheduled and unscheduled activities and tasks, as well as serves as a visual reminder to user 206 of the most pertinent and pressing activities he or she seeks to complete in a given day.

Tasks 212 component may be tracked to match entries associated with Goals 216 component. In fact, goals 216 component may provide queries to user 206 as to which goal related tasks to include in the set of tasks managed by tasks 212 component and which goal related tasks to schedule in calendar 214.

Notes 210 is a module component of daily digital planner 204, such as, notes 106 in FIG. 1. Notes 210 provides user 206 with a create notes pane to create new notes tied to a given date in calendar 214. Thus, user 206 may create daily notes that are linked to calendar 214. The notes created on a particular date will be displayed by notes 210 when that date in calendar 214 is selected by user 206. Users can also share notes with other connected users which, once accepted, will appear on the same date of the shared user.

Goals 216 is a module of daily digital planner 204 that records goals as designed, created, or selected by user 206. Goals 216 are generally any aim, objective, or desired result that user 206 would like to achieve.

Daily digital planner 204 may be configured to offer a version that is utilized by user 206 for personal, non-commercial matters or may be configured to offer a version focused on achieving commercial/business goals important to a company or commercial venture associated with user 206. In other words, goals 216 component may be utilized by user 206 to manage personal goals and/or business goals associated with user 206. A business goal may also be referred to as an imperative.

A business goal is a goal that may be desirable to increase efficiency, success, and/or productivity in a work environment. Such goals may assist user 206 in achieving his or her business objectives. A personal goal may be a goal that is desirable to improve health, interpersonal skills, money management, or other personal objectives.

A goal associated with goals 216 component is a SMART objective associated with a set of goal related tasks managed by tasks 212 component. A SMART objective refers to specific, measurable, actionable, relevant goal with a defined timeframe.

In order to accomplish goals, it is generally necessary to take steps to achieve this goal. Goals 216 modular component provides a master reminder of the goals as selected by user 206 and the means to track progress towards achieving the goals.

In one embodiment, user 206 manually enters and/or describes a goal user 206 desires to achieve. In another embodiment, in addition to user 206 manually providing the goals he or she seeks to achieve, the module for goals 216 may automatically provide user 206 with a predefined list of goals that may be of interest to the user. User 206 may select from the list of automatically presented goals or choose to dismiss this option.

Goals 216 component may prompt user 206 with queries regarding time and activities user 206 needs to perform in order to achieve or accomplish to goal. User 206 may select a single date to achieve the goal or a series of dates to accomplish the goal. This user selected date or date(s) are entered into calendar 214 and added to tasks 212 to be accomplished by user 206. Tasks 212 tracks a status for each goal related task. Thus, user 206 may track his or her progress in achieving the goal.

By including Goals 216 as part of daily digital planner 204, daily digital planner 204 provides greater benefit to the user. Daily digital planner 204 increases the potential and ability of user 206 to achieve his or her most important goals by providing a location that is easily accessible and a method for tracking his or her activities to determine whether they are in sync with the achievement of user 206's goals. Goals 216 may be related to any objective or aim pertinent to user 206, including but not limited to, personal matters or commercially related, business goals.

Lists 218 component is also a helpful and novel feature of daily digital planner 204. Lists 218 is a module component of daily digital planner 204 that allows user 206 to create and store multiple master lists of events relevant to User 206. These master lists may relate to personal and/or business, commercial matters for User 206.

A master list or checklist is a list of one or more items to be accomplished, purchased, or performed. In one embodiment, a checklist that is created in lists 218 is a selection of two or more items user 206 frequently purchases at a particular store or other location. For example purposes only, and without limitation, a checklist may be created in lists 218 that applies to a grocery store. User 206 thus creates a master checklist for grocery shopping. Thus, when user 206 goes to the grocery store, user 206 can easily check his or her master checklist of items to be purchased at this location.

A checklist created or managed by lists 218 component may be scheduled to be completed by a particular date associated with calendar 214. Additionally, each item on the master list can be individually associated with a date specific checklist Thus, user can select all or some of the items from user's master checklist and associate with a date to create a date specific task list associated with tasks 212 and calendar 214. This task list is entered as a single task item in associated with tasks 212 and calendar 214.

Another feature of lists 218 is that user 206 may delegate any items from a checklist to another individual and thus remove that item from his or her checklist Thus, there may be a network of users associated with user 206 who may receive items from either lists 218 and/or tasks 212. Additionally, these items may be designated and removed from the user's to do items and designated to another individual in a network of users associated with user 206. For example, user 232 may delegate one or more items or task lists to user 206. Likewise, user 206 may delegate one or more checklist items and/or one or more task lists to be completed by user B 232.

Master checklists may be created for any location where user 206 may need to utilize a checklist to obtain a set of items. Such locations include, but are not limited to, office supply stores, grocery stores, beauty supply stores, drugstores, pharmacies, home supply stores, and bookstores. In a further embodiment, lists 218 may provide information for price comparison for items included on a checklist Lists 218 may also provide recommendations for the best price for an item among stores in a certain geographic area.

Expenses 220 component is a module component included in daily digital planner 204. Expenses 220 component provides a location for user 206 to include any expenses associated with user 206. These expenses may relate to user 206's personal or professional activities. Expenses 220 may provide a record of expenses to be submitted for reimbursement, client billing, personal or business tax purposes, or time/expense management. Further, expenses 220 may offer user 206 with a means for recording his or her expenditures during one's day in order to create or meet a budget.

Expenses 220 allows user to create a record of a date and time in which an activity was performed and the associated expense associated with this activity. In this embodiment, daily digital planner 204 provides an add expenses field within a time and expenses pane associated with the homepage for daily digital planner 204. The user 206 may enter expenses, time, and/or miles within the time and expenses pane.

In another embodiment, expenses 220 may provide queries to user 206 on a daily basis or any other period of time by which user 206 may enter any amount of time, miles, and/or expenses incurred by user 206 during that period of time and could include attachments, such as pictures of the actual expense, receipts, miles, approved time on hard copy, etc.

Expenses 220 component tracks expenditures of user 206 over a period of time. Expenses 220 component includes a price comparison module, which provides best prices for various items of interest to user 206.

In one embodiment, computing device 202 may include or be attached to an electronic scanning device or camera that allows user 206 to electronically scan and store various items and documents associated with user 206's expenses to expenses 220. Thus, user 206 may scan or take a picture and store a copy of a receipt in expenses 220 and associate the receipt with either an activity that was scheduled in calendar 214, tasks 212, and/or lists 218.

In one embodiment, expenses 220 displays a set of time and expense entries added on a daily basis into an expenses pane. The set of time and expenses entries includes time entries, miles entries, and expenses entries entered by the user.

The set of time and expense entries includes a set of attachments. An attachment may be a scanned image, a digital photograph, an audio file, a document, or any other type of attachment. Thus, a user may create an attachment using, for example, but without limitation, a digital camera, a microphone, a scanner, or OCR.

Each time and expense entry may include a single attachment, two or more attachments, or no attachments. In other words, the set of attachments may include a single attachment associated with a single time and expense entry, two or more attachments associated with a single time and expense entry, two or more attachments associated with two or more time and expense entries, or no attachments.

In this manner, expenses 220 provides a consolidated view of all daily time entries, miles entries, and/or expenses entries with all associated attachments in a single location for review by user 206 and/or submission for reimbursement, tax documentation, or any other purpose. Expenses 220 may also consolidate all attachments in the set of attachments associated with a given time period into a single T&E attachments document. This consolidated T&E attachments document may be printed, downloaded, emailed, and/or exported into another application, such as Excel or any other application.

Journal 222 component allows user to write and record any text user 206 desires. Journal 222 may include any and all text editing features and functions included in software modules known to one of ordinary skill in the art. These text editing features and functions may include, but are not limited, to ability to edit the type, color, size, location of text as well as its location on the journal entry. Journal 222 allows user 206 to record his or her thoughts and opinions within the framework of daily digital planner 204.

Journal 222 component allows user to write and record any text user 206 desires. Journal 222 may include any and all text editing features and functions included in software modules known to one of ordinary skill in the art. These text editing features and functions may include, but are not limited, to ability to edit the type, color, size, location of text as well as its location on the journal entry. Journal 222 allows user 206 to record his or her thoughts and opinions within the framework of daily digital planner 204.

Journal 222 may have similar functionality to Notes 210. However, journal 222 entries may be created over time, reused, and saved independent of a specific date. In other words, journal 222 entries are not tied or linked to a specific date in calendar 214. Various documents and images may be also electronically and attached to Journal 222 from computing device 202.

Journal 222 allows for items recorded in Journal 222 to be grouped into categories. Categories are created by user 206. Categories may include, but are not limited to, lectures, speeches, journal entries, and messages. Journals may be modified and deleted as determined by user 206. Entries created and stored in Journal 222 do not need to be tracked, in contrast to entries entered in tasks 206, lists 218, goals 216, expenses 220, or leadership 228.

E-Card 224 component allows user 206 to store information that is typically stored on paper and plastic cards belonging to user 206. For example, contact information from insurance cards, health cards, memberships, rewards cards, identification cards, or any type of card may be stored in the e-Card 224 component. Thus, the objective of e-Card 224 is to help eliminate multiple cards that are carried in one's wallet or pursue.

User 206 may manually enter the information located on the card and store this information in e-Card 224 by typing on a keyboard, using a touch screen, or voice recognition system to enter card information, such as names, membership numbers, expiration dates, etc.

A digital picture of a card may also be saved into e-Card 224. In this example, user 206 may take a photograph of a card with a camera, such as a camera phone or other camera device, and save the photograph to e-Card 224.

E-Card 224 also permits user 206 to scan in a card and store the scanned image of the card in e-Card 224. The stored image may be assigned a title and also expiration date if applicable. The scanned image of the card is associated with the name of the type of insurance and associated company provider.

The image of the card from e-Card 224 may be presented as needed at various locations, including but not limited to, hospitals, schools, airports, medical offices, and various entities. E-Card 224 may also be used for airline and hotel user loyalty programs for storing identifying information of user 206 with these programs. Furthermore, the snapshot of the image may be sent via email or messaging via daily digital planner 204's configuration with computing device 202 to other users or entities.

In another embodiment, e-Card 224 may include OCR. Using OCR allows e-Card 224 to extract text from a scanned image and associated with a title or category relevant to the card from which the text originated.

Vault 226 is another module component of daily digital planner 204. Vault 226 is encrypted and has additional security features to protect the data stored in Vault 226. Vault 226 may require an additional pass-code or login key to allow user 206 to access the data stored in vault 226. Vault 226 serves as a secure location for storing sensitive matter, including but not limited to, personal documents, passwords, credit card information, and any identifying information such as, without limitation, social security numbers and driver's license numbers. Items may be manually entered by user 206 in the module components associated with vault 226 or may be scanned in via a scanner and/or OCR.

In one embodiment, leadership 228 is a module component of daily digital planner 204 that acts as a self-assessment mechanism to assist an individual in developing leadership values and self-improvement. In one embodiment, leadership 228 provides a predefined list of values. User 206 selects one or more values from the list of values.

In another embodiment, leadership 228 acts as a mechanism to assist an individual or corporation in achieving corporate imperatives and/or corporate values.

The values included under leadership 228 may be connected to attributes or characteristics of a leader that user 206 may choose to aspire to and/or imperatives and corporate values a business may wish to promote or encourage in employees, supervisors, management, and/or executives. Examples of such values that may be relevant to user may include, but are not limited to, motivation, courage, communication, and confidence. Leadership 228 may provide a reminder as to these values and query user 206 as to how he or she will use those values for self-improvement. Leadership 228 may query user 206 on a weekly basis.

User 206 has the ability to review the selected values associated with leadership 228 in daily digital planner 204's homepage as needed. Leadership 228 may ask user 206 to associate one or more tasks for improving the selected leadership value(s) to tasks 212. By associating a set of leadership related tasks with tasks 212, leadership 228 may assist user 206 in achieving these tasks by providing the motivation to accomplish a particular value.

Furthermore, Leadership 228 may include a year to date status self-assessment or supervisor assessment of the values as selected and set of leadership related tasks necessary to achieve the selected values. Leadership 228 allows user 206 to receive a type of report card with grades that rate his or her achievement of the particular values user 206 has selected.

Thus, leadership 228 modular component includes a set of leadership values associated with a user. Each leadership value may be selected by the user 206 or by a supervisor, manager, or other superior associated with the user. Each leadership value in the set of leadership values includes a set of leadership related tasks. Each task in the set of leadership related tasks is a task associated with demonstrating at least one leadership value in the set of leadership values.

Leadership 228 generates a ranking or score for associated with each leadership value in the set of leadership values. The ranking may be generated by leadership 228 based on a management ranking created by the user 206's supervisor, management, or superior. The ranking may also be generated based on a user provided self-evaluation rank or score. The ranking identifies how well the user performed the leadership related task and/or demonstrated a particular leadership value.

Daily digital planner 204 is a comprehensive, readily accessible, organizational tool. Daily digital planner 204 assists user 206 increases his or her productivity and to accomplish necessary goal related tasks to accomplish user 206's goals. By locating the modules described above, Master Planner 204 provides an overview of one's schedule and a means for coordinating activities, data, and overall goals. Additionally, daily digital planner 204 is located on computing device 202, which is readily accessible and usable by user 206. Further, daily digital planner 204 allows user 206 to share items from tasks 212 or lists 218 with other users with allowed access to daily digital planner 204.

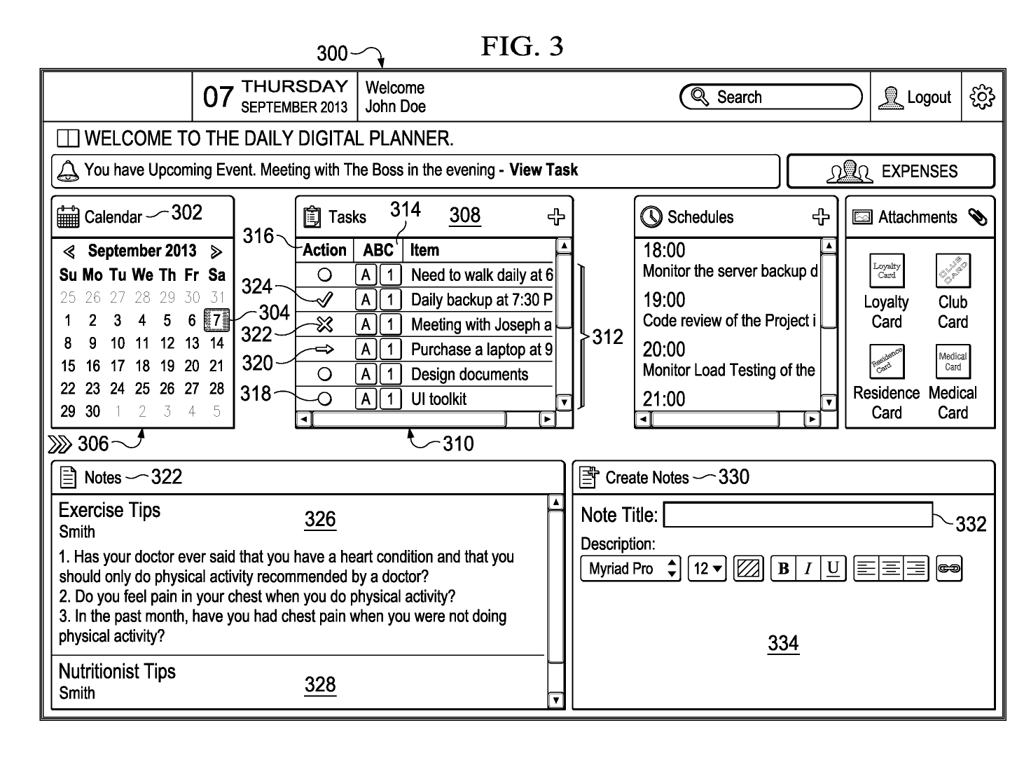

FIG. 3 is a pictorial illustration of a home page for a daily digital planner in accordance with one embodiment. Homepage 300 is a homepage generated by an integrated daily digital planner, such as homepage 112 in FIG. 1.

Homepage 300 includes calendar pane 302 generated by a calendar component of a daily digital planner, such as calendar 104 in FIG. 1 and calendar 214 in FIG. 2. This modular calendar component may be similar in function to calendar 104 and calendar 214 as previously described in FIG. 1 and FIG. 2.

Selected date 304 is displayed in digital calendar 306 within calendar pane 302. Selected date 304 is a user selected date. If user fails to select a date, selected date 304 is today's current date by default. In this example, selected date 304 is the current date.

In this embodiment, digital calendar 302 is displayed in a month calendar view showing every day in a given month associated with selected date 304. However, digital calendar 302 may also be displayed on homepage 300 in a day calendar view or a week calendar view.

Additionally, the daily digital planner depicts digital calendar 306 located on the left hand side of the display screen in accordance with an illustrative embodiment. However, the embodiments are not limited to this location or orientation of digital calendar 306. Digital calendar 306 in calendar pane 302 may be located on a right side of the display screen, at the bottom of the display screen, or at any other location within homepage 300.

Homepage 300 also includes tasks pane 308 generated by a tasks component of a daily digital planner, such as tasks 108 in FIG. 1 and tasks 112 in FIG. 2. Tasks pane 310 is a pane to enable a user to add a task 308 and display set of tasks 312.

When a user clicks or selects add a task 308 icon, the daily digital planner opens an add task entry field on homepage 300. The add task entry field is a text editor that enables the user to create a new task, name the task, delegate the task, select a priority, and choose whether to schedule a date and/or time for the task to be completed. If the user does not schedule a specific date and/or time for the task to be completed, the task is added to set of tasks 312 associated with the current date on digital calendar 306 and displayed in set of tasks 312 associated with the current date. If the unscheduled task is not completed by the end of the current date, the unscheduled task is forwarded to the set of tasks associated with the next day on digital calendar 304.

Set of tasks 312 is a set of tasks, such as set of tasks 132 in FIG. 1. Set of tasks 312 is a set of one or more tasks associated with selected date 304.

The tasks component associated with tasks pane 310 priorities set of tasks 312. Each task added to set of tasks 312 includes a task priority 314. Task priority 314 is an indicator of a priority associated with a given task. In this example, task priority 312 includes a letter and/or a number. In other words, tasks may be arranged in tasks pane 310 so as to prioritize tasks based on alphabetical and numerical designation.

For example, task 318 has task priority “A1”. The tasks component displays each task in set of tasks 312 in an order of priority. In other words, tasks having a higher priority or greater importance are displayed prior to tasks having a lower priority. Thus, a task having an “A1” priority would be displayed prior to a task having a “B 1” priority.

Each task in set of tasks 312 is displayed with a task status 316, such as task status 134 in FIG. 1. In this example, task status 316 includes an in progress task status, a deleted task status, a delegated task status, an assigned task status, a forwarded task status, or a no action task status. Task status 316 may also be referred to as “action” taken with regard to a given task.

For example, task 320 has a task status “no action” indicating the user has not yet taken any action to start this task or has not yet updated a status for this task. Task 322 has a task status “deleted”. Task 324 has a task status “completed” indicating the task has been finished.

Some tasks in set of tasks 312 are unscheduled. An unscheduled task is a task in set of tasks 308 that has not been assigned a specific time for the task to begin, for the task to occur, or for the task to be completed. For example, task 318 does not have a time scheduled for completion of the “testing” task. However, other tasks in set of tasks 312 may have a specific day and/or time scheduled associated with the task. For example, task 344 described as “daily backup at 7:30 p.m.” has been scheduled to occur at a specific day and time on digital calendar 306. Therefore, digital calendar 306 includes an entry identifying task 344 to be completed on selected date 304 at the specified time of seven-thirty in the evening.

Homepage 300 also includes notes pane 322. Notes pane 322 is managed by a notes component of a daily digital planner, such as notes 106 in FIG. 1 and notes 210 in FIG. 2. Notes pane 322 displays a set of notes created on selected date 304. The notes in set of notes may include any user created note. The set of notes may include a single note, two or more notes, as well as no notes. In this example, the set of notes includes note 326 and note 328.

A user creates a new note in create notes pane 330. Create notes pane 330 includes a note input field 334 which is a digital replica of a sheet of paper or notepad. User 206 may create a new note by typing or entering notes using any inputting device on computing device 202. Create notes pane 330 includes a note title and description field 332 enabling the user to give a newly created note a title and/or description. Create notes pane 330 further includes buttons or icons that allow the user to alter the size, color, and type of font used to create the new note. Create notes pane 330 may further include other word editing functions and features, such as the functions and features commonly found in creating and sending an email.

Homepage 300 optionally includes personalization by including a name of a user. Furthermore, daily digital planner in FIG. 3 may provide specific tips as requested by a user.

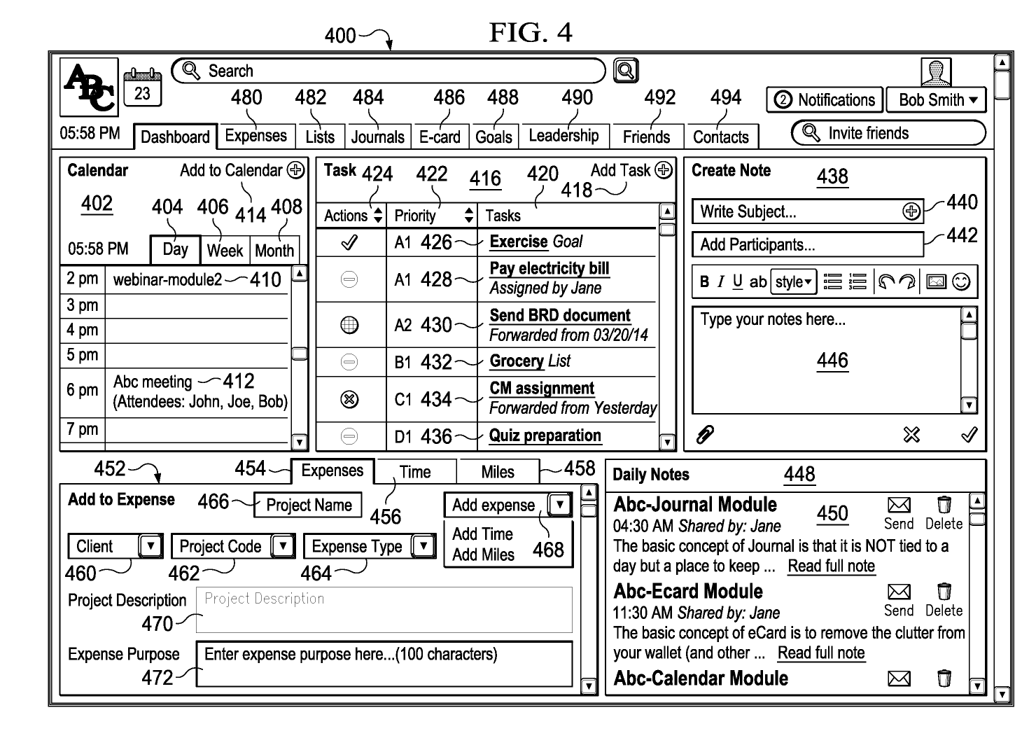

FIG. 4 is a pictorial illustration of a home page for a daily digital planner having a time and expenses pane in accordance with one embodiment. Homepage 400 is a homepage generated by an integrated daily digital planner, such as homepage 112 in FIG. 1 and homepage 300 in FIG. 3.

Homepage 400 includes digital calendar 402. A user may select to display digital calendar 402 with a day calendar view 404, a week calendar view 406, or a month calendar view 408. In this example, digital calendar 402 is displaying day calendar view 404.

Digital calendar 402 includes a set of entries identifying events and/or tasks scheduled for the selected date. In this example, the set of entries includes entry 410 scheduled for two o'clock and entry 412 scheduled for six o'clock.

A user may create a new entry in calendar by clicking or selecting “add to calendar” 414. The new entry created by the user may be scheduled for the selected date or for a different date in the future.

A tasks component manages tasks pane 416. The tasks component is an integrated modular component, such as tasks 108 in FIG. 1 and tasks 112 in FIG. 2. When a user clicks or selects “add a task” 418 icon, the daily digital planner opens an add task entry field on homepage 400 that enables the user to create a new task.

Set of tasks 420 is a set of tasks, such as set of tasks 132 in FIG. 1 and set of tasks 312 in FIG. 3. Set of tasks 420 is associated with a selected date.

Each task added to set of tasks 420 may include a task priority 422. In this example, tasks are arranged in tasks pane 308 so as to prioritize tasks based on alphabetical and numerical designation. Tasks having a higher priority or greater importance are displayed prior to tasks having a lower priority. For example, task 426 and 428 have a highest priority of “A1”. Task 430 has a second highest priority “A2”. Task 432 has a third highest priority “B1”. Task 430 has a next highest priority “A2”. Task 432 has a priority “B1”. Task 434 has a priority “C1” placing it at fifth highest priority. Finally, task 436 has a priority “D1”, which is the lowest priority in this non-limiting example. Thus, task 434 is displayed last in tasks pane 420.

Each task added to set of tasks 420 may include a task status 424 indicating user “actions” taken with regard to each task. For example, task status 424 indicates task 426 is completed and task 434 has been deleted or canceled by a user.

A user may create a note using create notes pane 438. The user may enter a subject or title for the note in subject field 440. The user may select one or more users from a group of networked users, such as user 232 in Figure, to receive a copy of the note user is creating by entering the participants in the add participants field 442. The user writes the new note in note input field 446.

Daily notes pane 448 displays set of notes 450 created on the selected date. The notes in set of notes 450 may include a single note, two or more notes, as well as no notes. Each note in set of notes 450 may optionally include a date and time at the top of each note.

A note in set of notes 450 may be configured to be sent either via text message to either the primary user or another individual. Additionally, the notes component may include a feature that allows the user to email his or herself a copy of notes to the user's email account.

An expenses component manages time, miles, and expenses entered by the user on a daily basis. The expenses component is a component for creating, managing, and tracking expenses, miles, and time, such as expenses component 220 in FIG. 2.

The user may enter daily time, miles, and expenses into T&E pane 452. Time and expenses pane 452 includes expenses tab 454, time tab 456, and miles tab 458. When the user selects expenses tab 454, the expenses component displays all expenses associated with the selected date. The user selects time tab 456 to view all time entries associated with the selected date. The expenses component displays all miles entered by the user associated with the selected date in response to the user selecting miles tab 458.

The time and expenses pane 452 includes fields for the user to select client 460, project code 462, and expense type 464. The user may enter a project name 466. Time and expense pane 454 also includes fields prompting the user to enter project description 470 and expense purpose 472.

The user selects whether to add an expense, add time, or add miles from a drop down menu 468. In this example, the user has selected add expense 468. The expenses modular component has provides an “add to expense” data entry field, as shown in FIG. 4. The data entered into time and expenses pane 452 will be saved by expenses component as an expense associated with the selected date.

If the user selects “add time” from the drop down menu 468, the expenses component provides an “add to time” data entry field in which the user may create a new time entry. In this example, the expenses modular component configures and saves the data entered into time and expenses pane 452 as a time entry associated with the selected date.

Likewise, if the user selects “add miles” from the drop down menu 468, the expenses modular component provides an “add to miles” data entry field in which the user may create a new miles entry. In this example, the data entered into time and expenses pane 452 will be configured and saved as a miles entry associated with the selected date by the expenses component.

Homepage 400 includes a plurality of tabs for accessing a plurality of modular components within the daily digital planner. Each of tabs 480-494 is associated with one of the modular components of daily digital planner. In this example, the tabs include expenses tab 480, lists tab 482, journals tab 484, E-card tab 486, goals tab 488, leadership tab 490, friends tab 492, and contacts tab 494.

When the user selects one of the tabs 480-494, the modular component associated with the selected tab opens. For example, when the user selects lists tab 482, the lists component opens a lists pane in homepage 400 enabling the user to view, edit, delete, create, or otherwise modify master lists, checklists, and task lists associated with lists component.

When the user selects the friends tab 492, the user may view a list of networked users having privileges to send data to the daily digital planner and receive data from the daily digital planner. For example, a user in the set of networked users may have privileges to view and/or modify data shown in a group calendar view of the daily digital planner. For example, appointments, tasks, events, and other activities scheduled for multiple users in the set of networked users may be shown in the group calendar view to create a shared calendar.

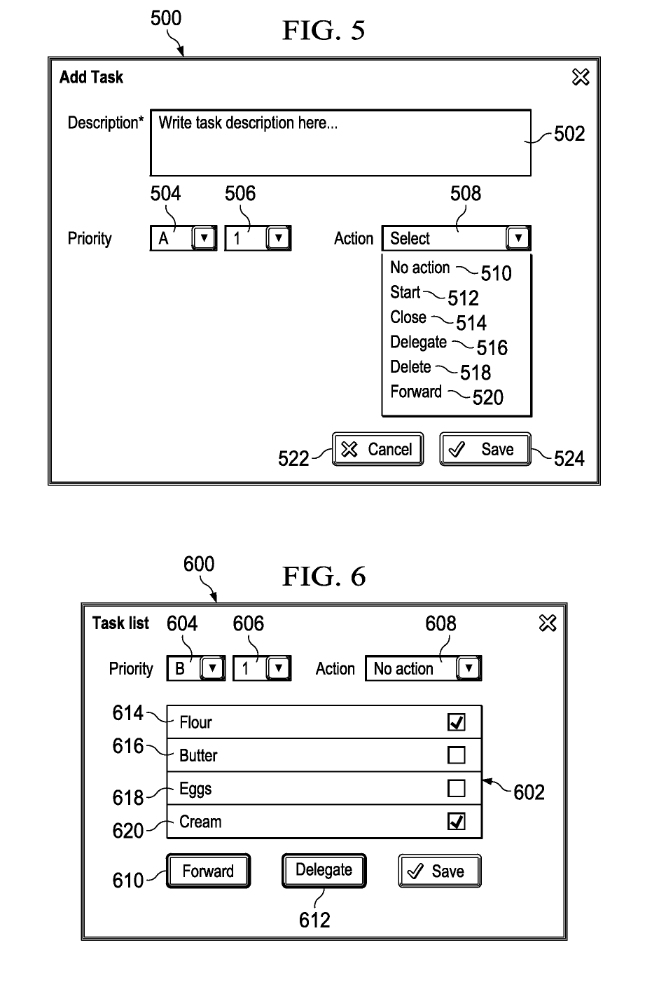

FIG. 5 is a pictorial illustration of an add task field associated with a tasks modular component of an integrated daily digital planner in accordance with one embodiment. A tasks component opens an add a task pane, such as add task pane 500, in response to a user selecting an add a task icon on a tasks pane in the daily digital planner homepage, such as add a task 310 in FIG. 3 and add task 418 in FIG. 4.

A tasks modular component generates add task pane 500. Add task pane 500 comprises a description field 502, a priority 504-506, and a task status 508. The user enters a description of the task being created in description field 502. The user may optionally select a priority using alphabetical priority 504 and/or numerical priority 506 drop down menus. The user may add a task status using action drop down menu 508 to select a task status. The task status indicating an action taken with regard to the task. The task status selected may include no action 510 taken, start 512, close 514, delegate 516 to another user, delete 516 task, or forward 520 task to a different date on the digital calendar.

The user may cancel or delete the task by selecting cancel 522. The user may save the newly created or edited task by selecting save 524.

FIG. 6 is a pictorial illustration of a task list associated with a tasks modular component of an integrated daily digital planner in accordance with one embodiment. Task list 600 is a task in a set of tasks that is scheduled to be completed on a user selected date. Task list 600 is displayed to user in an editable form to enable the user to update, edit, delete, or otherwise modify the task list.

The user may optionally select a priority using alphabetical priority 604 and/or numerical priority 606 drop down menus. The user may add or update a task status for task list 600 using action drop down menu 608 to select a task status. In this embodiment, the user may select to forward task list 600 to be completed on another date in the future by selecting forward 610 tab. The user may also select to delegate task list 600 to another user in the group of networked users by selecting delegate 612 tab.

Task list 600 is a checklist of items to be obtained. Each item in task list 600 includes an indicator 602 that can be checked off to indicate that the item in task list 600 has been purchased, acquired, or otherwise completed.

In this example, task list 600 is a grocery list comprising items 614-620. As the user obtains each item on the checklist, the user may check off that item. As shown here, item 614 and item 620 is checked off. Items 616 and 618 are not checked off, indicating that the user has not yet purchased items 616-618.

Here, task component will update the task status for task list 600 to show that task list 600 is in progress but not yet completed. When all items on task list 600 are checked off, the tasks component will automatically update a task status for task list 600 to show that task list 600 is completed.

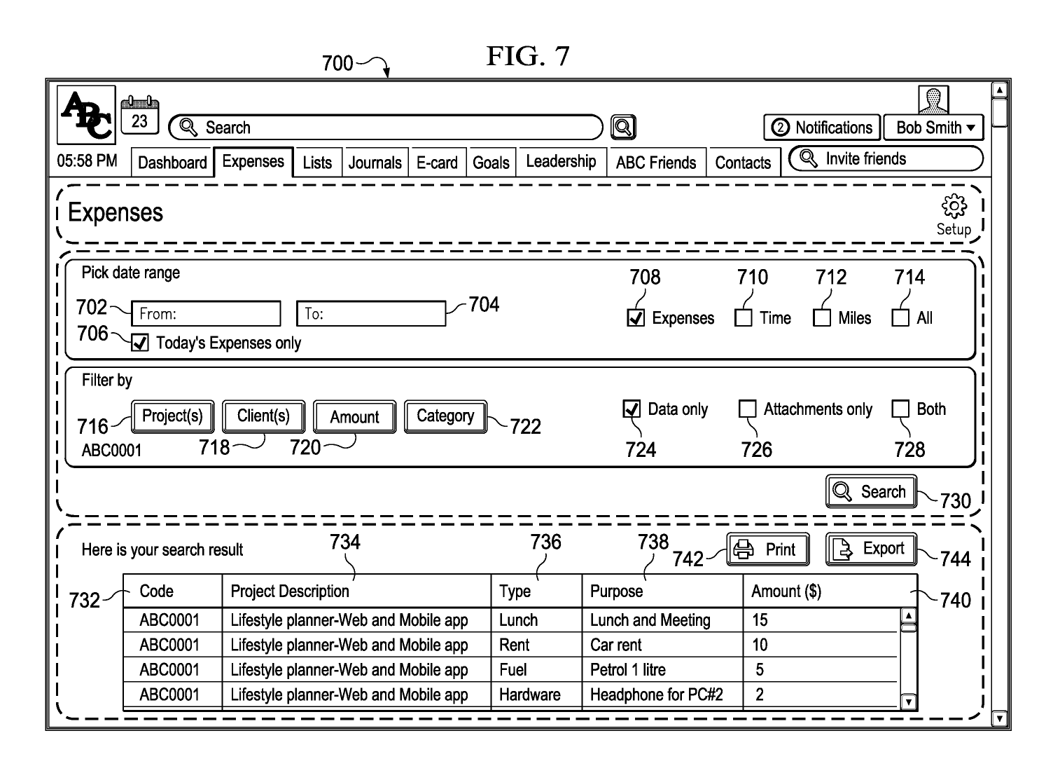

FIG. 7 is a pictorial illustration of an expenses search result associated with an expenses modular component of a daily digital planner in accordance with one embodiment. An expenses module, such as expenses 220 in FIG. 2, opens expenses pane 700 in response to a user selecting an expenses tab on the daily digital planner homepage.

The expenses module performs a search of expense over a selected period of time. The expenses module sorts expenses, time, and miles entries stored in expenses module by date, client, project code, amount, and/or category for any user selected date range. The user may perform a search of expenses, time, or miles entered into time and expense over a selected period of time. The user selects a date range from 702 a starting date to 704 an ending date for the selected time period. The user may also select to view today's expenses only 706.

The user indicates whether the user chooses to view only expense entries 708, only time entries 710, only miles entries 712, or all entries 714. If the user selects all entries 714, the expenses component will display all expense entries, time entries, and miles entries for the selected time period.

The user may optionally choose to filter the search by project 716, client(s) 718, amount 720, or category 722. The user may also choose whether to limit the search to data only 724, attachments only 728, or indicate that expenses module should include both 728 data and attachments in the search results. In this example, the user has selected search 730 that covers only expenses 708 and data only 724.

In another embodiment, if the user selected the attachments only 726, the expenses modular component would consolidate all attachments associated with the T&E entries for the given time period selected in fields 702-704. The search results showing the consolidated attachments could then be printed, emailed, downloaded, and/or exported into another application, such as, but without limitation, a billing application, spreadsheet, and/or tax preparation application.

The expenses component displays all expenses entries for the selected period of time in the search result. The expenses component optionally presents the search results with project code 732, project description 734, type 736 of expense, purpose 738 of expense, and/or amount 740 of the expense.

In another embodiment, the expenses module may provide search results listed in a set of categories, such as, airfare, cars, hotels, and meals. In yet another embodiment, the expenses component may generate a line graph, bar chart, pie chart, or other representation illustrating expenses, time, and/or miles entered over a given period of time. For example, the expense module may generate an expenses summary graph consolidating the costs associated with each category of expenses over the user selected period of time in expenses pane 700.

The user may choose to print 742 the search report or export 744 the search report to one or more other applications, such as, but without limitation, Microsoft Excel or any other application.

In another embodiment, if user selects time 710, the expenses component displays all time entries for the selected period 702-704. In this example, the search result includes a time or hours field in the search results in addition to one or more of the project code 732, project description 734, and/or other information associated with each time entry.

In still another embodiment, if user selects miles 712, the expenses component displays all miles entries for the selected period 702-704. In this example, the search result includes a “total miles” and/or a reimbursement rate per mile. The search result may optionally include a field for a starting odometer reading and an ending odometer reading in the search results in addition to one or more of the project code 732, project description 734, and/or other information associated with each miles entry.

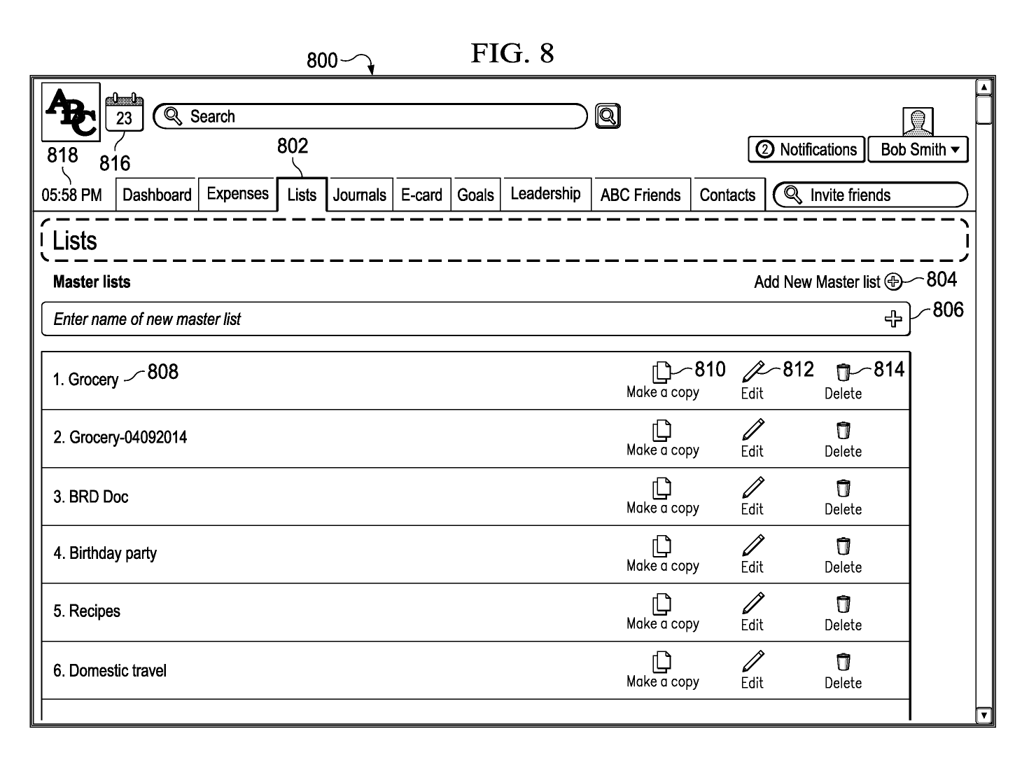

Referring now to FIG. 8, a pictorial illustration of a master lists page generated by a checklist modular component of a daily digital planner in accordance with one embodiment. A lists module, such as lists 218 in FIG. 2, maintains user created master lists, customized checklists, and scheduled task lists for the user.

Lists pane 800 in this example shows master lists created by the user. Lists pane 800 is displayed when user selects lists tab 802. A master checklist is a template or predefined list of items that is used on a regular or repeating basis. Master checklists may be created for grocery shopping, office supplies, planning a party, recipes, or any other purpose. For example, a master grocery list may include a list of staple items that are typically purchased whenever the user goes to the grocery store.

The user may enter a name of a new master list to be created by the user by selecting add new master list 804 icon. The user enters a name or description of the new master list in master list name field 806. The user is then prompted to create a new list of items to populate the new master list or to copy a list of items from a pre-existing master list.

Each entry in lists pane 802 represents a master checklist which may include two or more sub-master checklists. In other words, entry 808 titled Grocery is a master checklist. When the user selects entry 808, the lists module will open the master checklist Grocery, the master grocery list may be a single master grocery list. However, in another embodiment, the master grocery list 808 may include two or more sub-master grocery lists.

For example, when the user selects to open entry 808 for the grocery master checklist, the grocery master checklist may include a first master checklist for the local supermarket, a second master checklist for the farmer's market, and a third master grocery list for the health food store.

The user may make a copy 810 of a selected master list, edit 812 the selected master list, or delete 814 a master list that is no longer needed.

In this embodiment, the daily digital planner may optionally display a current date 816 and/or a current time 818 associated with lists pane 800. New lists created by the user may be associated with the current date 816 if the user fails to assign or schedule the newly created list to be completed on a particular date in the digital calendar.

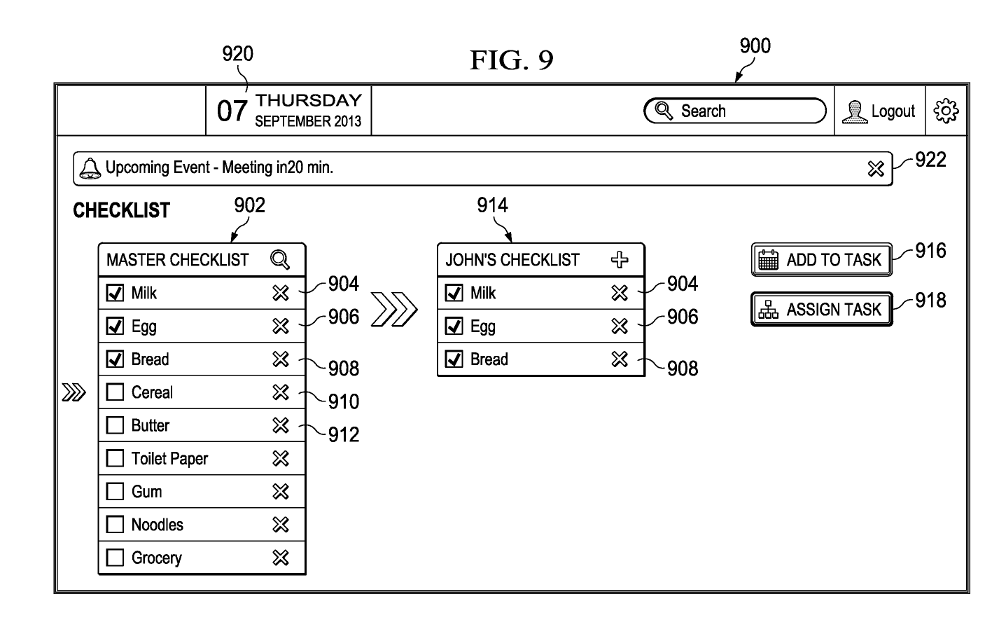

FIG. 9 is a pictorial illustration of a customized checklist associated with a checklist modular component of a daily digital planner in accordance with one embodiment. Lists pane 900 is a screenshot of master checklist 902 and customized checklist 914 created by a user. Lists pane 900 is generated by a lists module, such as lists 218 in FIG. 2.

In this illustrative embodiment, lists pane 900 depicts master checklist 902 connected to grocery shopping. Master checklist 902 is a template list of items the user commonly purchases when the user goes to the grocery store. In this example, master checklist 902 includes a list of items commonly purchased by the user when the user shops at the grocery store, such as items 904-912.

The user selects one or more items from master checklist 902 to copy over into customized checklist 914. A customized checklist is a checklist assigned to a particular user. A task list is a checklist assigned to a particular user and scheduled to be completed on a particular date. The master checklist 902 and customized checklist 914 includes a location for marking off when an item has been obtained in each customized checklist and task list.

In this example, the user has selected to copy items 904, 906, and 908 into customized checklist 914. However, the user has not selected items 910 and 912, so the checklist module does not include items 910 and 912 from master checklist 902 in customized checklist 914.

The user may select to assign customized list 914 as a task to another user by selecting assign task 918. An additional feature of lists component is to assign any items included in one of the created customized checklists or task lists to another user from the group of networked users associated with the lists module. The users in the group of networked users are users that have been pre-approved to be in a network of uses and/or share data associated with the daily digital planner. For example, spouses and children may be included in a “Family” category within the group of networked users. In this non-limiting example, the user may assign the grocery customized list 914 to be completed by the user's spouse if the user's spouse is included in the set of networked users connected to the daily digital calendar.

A user may request from another user to pick up a certain item if user is unable to complete that item. Thus, users in the group of networked users can share items from checklists and assist one another in completing purchases of these items.

Similarly, items may be assigned to be completed in a tasks module component of the daily digital planner, such as a daily digital planner 100 in FIGS. 1 and 204 in FIG. 2. The user may choose to schedule customized list 914 to be completed as a task by the user on a particular selected date in calendar component by selecting add to task 916. In this example, the daily digital planner adds an entry to the digital calendar indicating the customized list 914 is scheduled to be completed as a task on the date selected by the user. When the selected date and/or scheduled time for completing a task approaches, the daily digital planner provides an alert 922 reminding the user of the upcoming scheduled event or task to be completed.

In one non-limiting embodiment, if the user does not schedule customized checklist 914 to be completed on a particular date, customized checklist 914 is associated with current date 920. Thus, checklist items and tasks may be shared between the checklist modular component and tasks modular component of a daily digital planner.

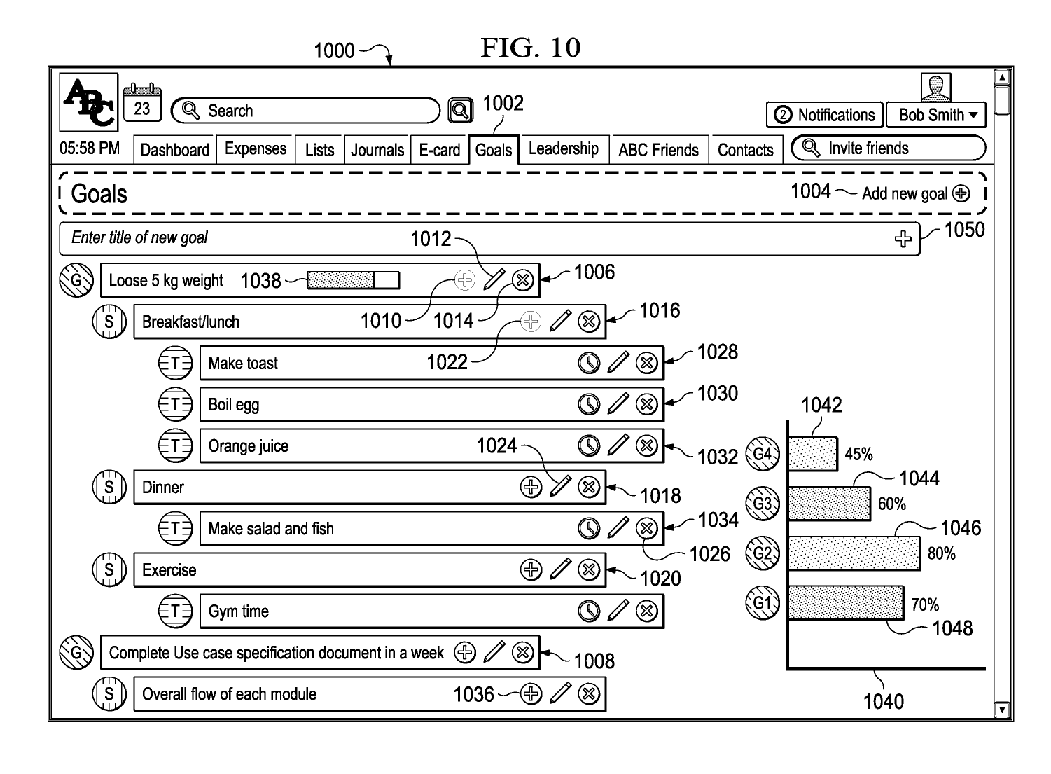

Turning now to FIG. 10, a pictorial illustration of a goals management pane associated with a goals modular component of a daily digital planner is shown in accordance with one embodiment. Goals pane 1000 is a panel presenting a set of user selected goals, goal related tasks associated with each user selected goal, and a goal progress report. A goals modular component, such as goals 216 in FIG. 2, generates goals pane 1000 in response to the user selecting goals tab 1002.

A user selects “add new goal” 1004 to open a create goals field. The user may create the goal by entering a textual title or description of the goal. In one embodiment, goals pane 1000 may include “enter title of new goal” 1050. The user selects “enter title of new goal” 1050 to create a title and/or description for a newly created goal.

In another embodiment, the user may select the goal from a template list of pre-defined goals. A goal may be any goal selected or created by the user. For example, a goal may be, without limitation, to lose a specific amount of weight, complete a project, buy a home, or any other user created goal. In this example, the user has created goal 1006 and goal 1008.

The user may select add a sub-goal 1010 to create a new sub-goal associated with goal 1006, edit 1012 to edit goal 1006, or delete 1014 to delete goal 1006. The user may create one or more user selected sub-goals for each goal. The set of sub-goals may include a single sub-goal, two or more sub-goals, as well as no sub-goals. However, in this embodiment, the goals component of the daily digital planner only permits the user to add three (3) sub-goals to each goal.

In this non-limiting example, goal 1006 includes three sub-goals, namely sub-goal 1016, sub-goal 1018, and sub-goal 1020. Goal 1008 includes only a single sub-goal. The user may select add a task 1022 to create a new task associated with sub-goal 1016. The user may also select to edit 1024 sub-goal 1016 or delete 1026 sub-goal 1016.

The goals module permits a user to create a set of tasks associated with each sub-goal. The set of tasks include tasks and activities intended to assist the user in achieving the goal. The set of tasks may include a single task, as well as two or more tasks. In this example, sub-goal 1016 includes tasks 1028-1030. Sub-goal 1018 includes a single task 1034. Likewise, the user has assigned a single task to sub-goal 1020. The user may select add a task 1036 to create a new task for the sub-goal associated with goal 1008 or schedule a task to occur on a particular date and/or time in the calendar module.

For example, as seen in FIG. 10, the tasks associated with the goal “lose five kilograms weight” and sub-goal exercise 1020 includes the task “gym time”. The user may schedule gym time in the digital calendar of the calendar component and add the task to the set of tasks tracked by the tasks module of the daily digital planner. The user may set a priority for the task “gym time” and update the task status to indicate whether the user actually completed the scheduled gym time. Thus, a few or all of the goal related tasks 1028-1034 may also be assigned a calendar date so as to put the specific tasks in the calendar module and assist the user in achieving the overall goal by holding him or her accountable to complete these particular tasks on the scheduled date and/or time.

Furthermore, the calendar component provides reminders and alerts to the user when the date and/or time to complete a goal related task, such as tasks 1028-1034 is approaching. Under the calendar modular component, such as calendar 214 from FIG. 2, if a user does complete the goal related task, he or she may designate that task as completed for the day. If the task needs to be carried over to another day, the user may designate that task as “in progress” or “forwarded”.

In one embodiment, the goals modular component prompts a user for a date to associate with a task that has been associated with a specific goal in the set of goals included by the user. The goals oriented modular component also requests whether the task is recurring, such as an exercise task that is to recur on a daily or weekly basis.

In another embodiment, as an additional step to assist the user in achieving goals, the goals oriented modular component may present an automatically included list of goals to user when the user opens or activates the goals pane 1000 of the daily digital planner. Thus, a list of automatically presented goals may include, “lose X number of pounds,” in which case the user may select the number of pounds he or she would like to lose. Additional goals may be selected by the user from the list referencing any number or type of personal and professional goals. The user is then asked to associate a set of tasks with the specific goal and to schedule particular tasks in the calendar component of the daily digital planner.

In this non-limiting embodiment, the goals component provides the user with a progress report showing the user's progress toward achieving each of the user selected goals and/or sub-goals. The progress report may include a graph, bar chart, progress indicator, pie chart, a percentage, or other data indicating a user's progress toward accomplishing the goal.

The goal component may optionally display a progress indicator, such as indicator 1038, associated with a goal or sub-goal. The progress indicator 1038 indicates how much progress or how close the user is toward accomplishing the goal or sub-goal.

The goals component may also optionally provide the summary or status for each goal and/or sub-goal as a bar chart, line graph, pie chart, or other summary representing the user's progress toward achieving each goal and/or sub-goal. Here, bar chart 1040 displays a status bar 1042-1048 for each goal. For example, status bar 1046 indicates that the user is very close to achieving the goal associated with status bar 1046.

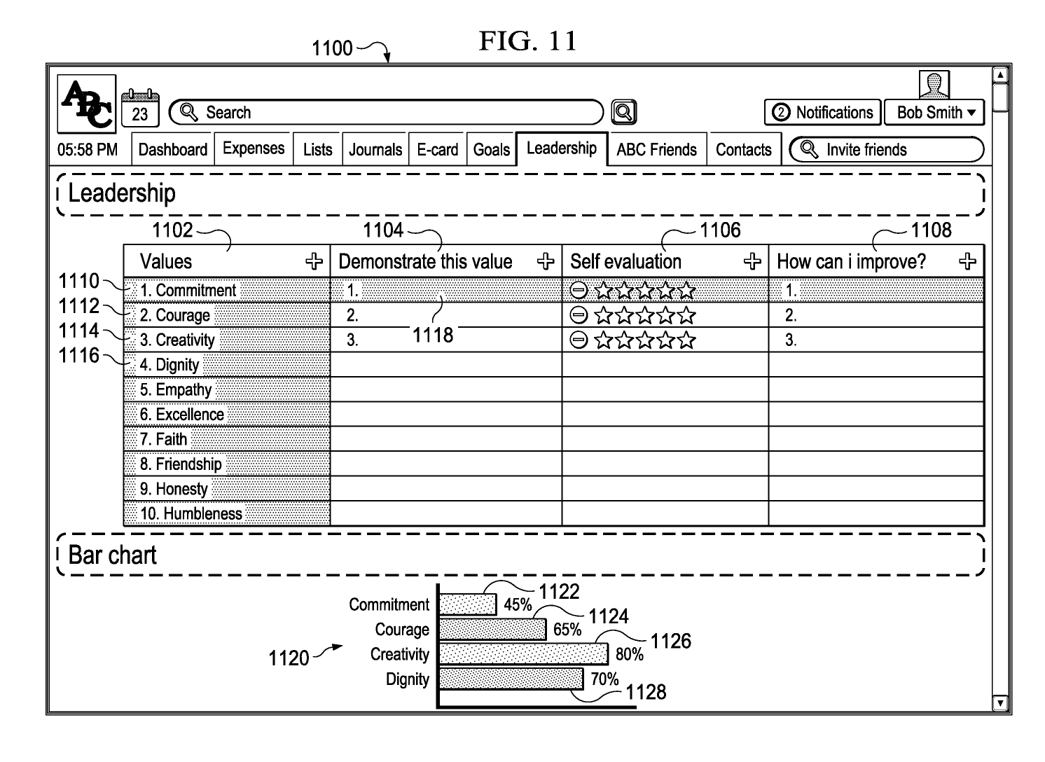

FIG. 11 is a pictorial illustration of a leadership pane associated with a leadership modular component of a daily digital planner in accordance with one embodiment. Leadership pane 1100 is displayed by a leadership modular component, similar to leadership 228 in FIG. 2. The leadership modular component is similar to the goals modular component.

Leadership pane 1100 includes set of values 1102. The set of values 1102 may be user selected values or corporate values. Corporate values are selected by a user, the user's manager, supervisor, boss, or other superior. Corporate values may also be referred to as imperatives. Corporate values ensure that leadership and corporate values are aligned for a successful and productive partnership.

In this non-limiting example, set of values 1102 includes commitment 1110, courage 1112, creativity 1114, and dignity 1116. However, in other embodiments, set of values 1102 may include any leadership values and/or corporate values.

The leadership modular component allows a user to select each value in set of values 1102 and store a set of tasks and/or dates to achieving those values. Furthermore, the leadership modular component may be useful for companies to train managers and executives. By assigning a set of values and tasks and including in a leadership module component, such as leadership 228 in FIG. 2.

The leadership modular component assists users in understanding the values they believe in and continuously self-monitor their performance demonstrating this value. In another embodiment, the leadership modular component determines whether the user is achieving and/or demonstrating corporate values 1104.

Thus, in one embodiment, a user selects the set of values 1102 and identifies a set of tasks that will demonstrate this value 1104. For example, the user may enter “arrive to work on time every day” into field 1118 as a task that will demonstrate the value commitment 1110. The set of leadership related tasks may include a single task, as well as two or more tasks. In this non-limiting embodiment, the leadership modular component only permits a user to select three tasks for each selected value in set of values 1102.

The user may schedule the set of tasks on the digital calendar associated with the calendar modular component. The user may also set a priority for each task in the set of tasks associated with “demonstrate this value” 1104. The tasks modular component will display the set of tasks with the priority, task status, and other task related information for the leadership related tasks.

The leadership modular components provide a user self-evaluation or it could also be an evaluation by management if the module is being used in a corporate environment. Self-evaluation 1106 comprises self-evaluation points or a management created ranking. The user ranks how the user is performing to the values by their execution on actions or management ranks the user's performance to the corporate values based on the users actions and/or progress toward demonstrating the corporate values. In this non-limiting embodiment, the ranking for each identified value is on a scale of one (1) to five (5). However, in another embodiment, the ranking may be a percentage ranking, a point system ranking, or any other type of rank.

In this embodiment, the leadership modular component may also generate a self-evaluation summary. The self-evaluation summary may include bar chart 1120, pie chart, graph, or other representation of the results of the user's self-evaluation. In this example, bar chart 1120 includes a bar indicator 1122-1128 for each identified value in set of values 1102. For example, the bar indicator 1122 shows the results of the user's self-evaluation for the value “commitment” 1110. Based on the user's self-evaluation and/or management ranking score 1106, the user can identify self-improvement opportunities and list them for each value in “How can I improve?” 1108.

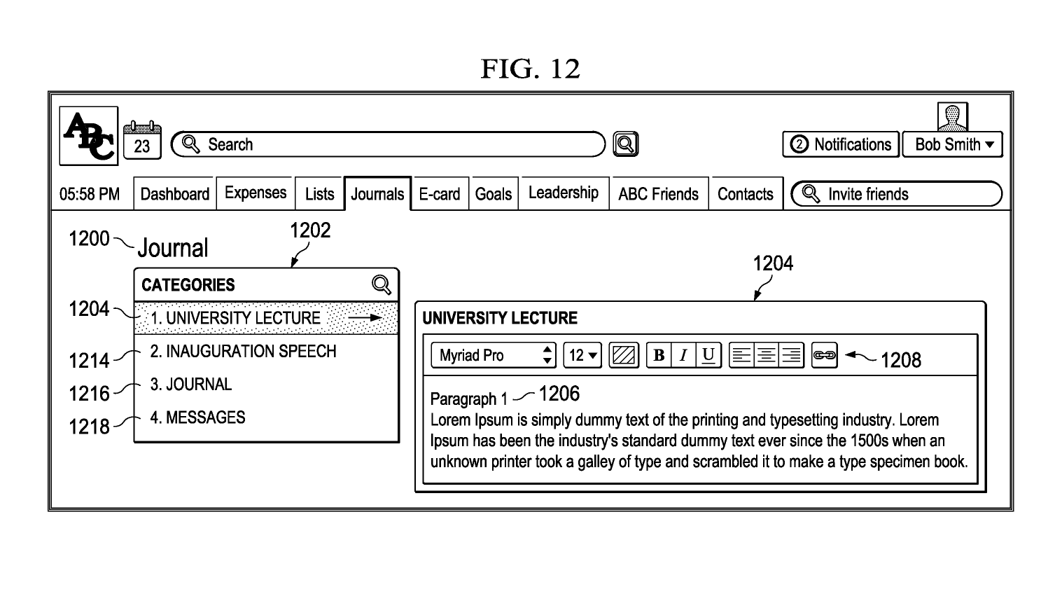

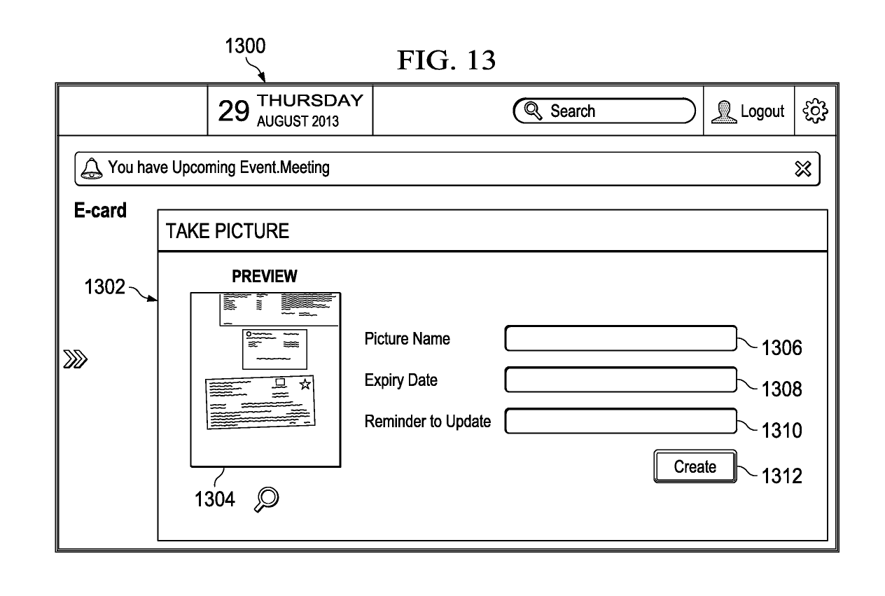

Referring now to FIG. 12, a pictorial illustration of journal categories associated with a journal modular component of a daily digital planner is depicted in accordance with one embodiment. A journal modular component, such as journal 222 opens an electronic journal 1200 in response to a user selecting a journal tab on the daily digital planner homepage, such as journal tab 484 shown in FIG. 4.

The journal 1200 includes a set of user created journal categories 1202. A journal category may be any user created category for journal entries, such as, but without limitation, university lecture 1204, inauguration speech 1214, journal 1216, and/or messages 1218.

The journal 1200 displays a selected journal entry in a journal text editor 1208. The journal 1200 permits the user to attach one or more attachments to each journal entry 1206. The attachment may include a document, a photograph, a scanned document, a recording, or any other type of attachment.

FIG. 13 is a pictorial illustration of a create e-Card pane associated with an e-Card modular component in accordance with one embodiment. An e-Card modular component generates a create e-Card pane 1300 of the daily digital planner in response to a user selection to create, add, or edit an e-Card. The e-Card modular component is a component of a daily digital planner, such as e-Card 224 in FIG. 2.

The e-Card module provides the user with the ability to take a picture or scan the front and back of a card to be saved as a new e-Card. The computing device associated with the daily digital planner may be a mobile computing device, such as a tablet or smart phone, which includes a built-in camera. The computing device may also be attached to a scanning device, which the user may utilize to scan an image of a card to be stored with the e-Card module.

In this embodiment, the user has selected take a picture 1302 option and taken a picture of a card he or she seeks to store in the e-Card module component using a camera built into the computing device. The e-Card module may optionally display preview 1304 of the digital image captured by the digital camera. The preview 1304 is an image of the picture or scanned copy of the card the user has selected as part of the process for creating an e-Card.

The user assigns a name to image shown in the preview 1304 of the card stored in the e-Card module with master planner by entering a name in name field 1306. In another embodiment, the user also selects a category for the new e-Card. A category may include, without limitation, memberships, identification, insurance, loyalty, and so forth. Thus, if the user is creating an e-Card for a grocery store reward card, the user may select a “loyalty” category for the new e-Card.

The user assigns an expiration date, if applicable, to the type of information stored on the card by entering an expiration date into expiry date field 1308. For example, the card may reference a particular type of insurance or other service with an expiration date, including, but not limited to credit cards, membership cards, library cards, insurance cards, driver's license, and any other card having an expiration date.

The user may optionally select to receive a reminder 1310 for updating the image stored in the e-Card module. The e-Card module may provide the reminder a predetermined number of days prior to the occurrence of the expiration date.

In another embodiment, the user may also enter data associated with creating a new e-card that includes a card number, such as an account number, policy number, identification number, or any other numbers associated with the card. The user may also be provided with the option for including phone numbers provided on the card, such as insurance company contact phone numbers.

When the user is finished, the user selects to create 1312 an e-card having the image 1304 and description data entered by the user, such as, but without limitation, the category, name and other information entered into fields 1306-1310.

In this embodiment, the image of the card is stored in the e-Card module as a newly created e-card such that information printed on the front and back side of the physical card is visible in the e-card. The e-Card module provides input field giving the user the ability to manually enter data associated with the information on the e-Card.

In this embodiment, the user scans or takes a picture of a physical card to create an e-Card. However, in other embodiments, the e-Card module may include an Optical Character Recognition (OCR) component which may make the text include in an image machine readable. The OCR component of the e-Card module may then automatically select the text and store along with the image of the associated card.

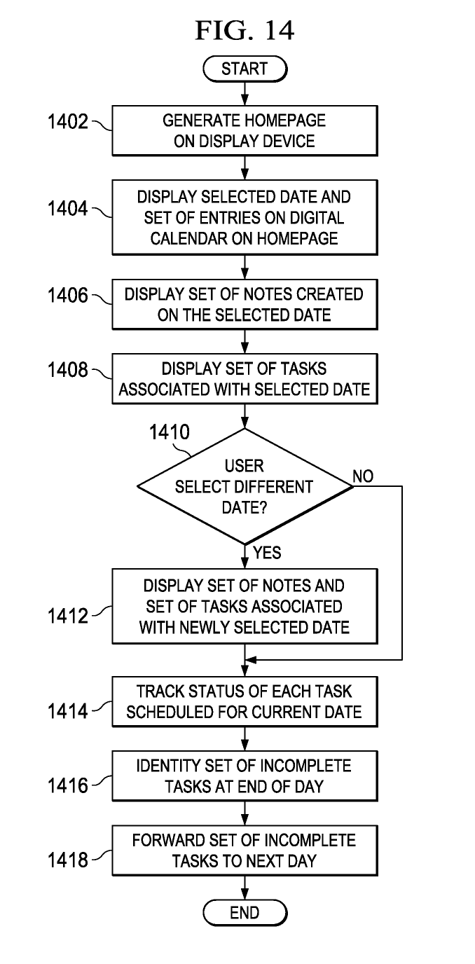

Referring to FIG. 14, a flowchart of a process for a daily digital planner having a plurality of modular components is depicted in accordance with one embodiment. The method described in FIG. 14 is in accordance with an exemplary method for using daily digital planner 100 in FIG. 1 and daily digital planner 204 in FIG. 2.

The process begins by generating a homepage on a display device associated with a computing device (step 1402). A selected data and set of entries associated with a selected date are displayed on a digital calendar on the homepage (step 1404). A set of notes created on the selected date is displayed on the homepage (step 1406). A set of tasks associated with the selected data is displayed in the homepage (step 1408).

A determination is made as to whether the user selected a different date (step 1410). If no, the process continues to step 1414. If a different date is selected by the user at step 1410, a set of notes and set of tasks associated with the newly selected date is displayed (step 1412).

A status of each task scheduled for the current date is tracked (step 1414). A set of incomplete tasks is identified at the end of the day (step 1416). The set of incomplete tasks is forwarded to the next day (step 1418) with the process terminating thereafter.

The embodiments are not limited to the process shown in FIG. 14. In another embodiment, the daily digital planner may also provide additional functionality associated with a plurality of additional modular components, such as, but without limitation, the expenses module, goals module, lists module, or any other modules described in FIGS. 1-13 above.

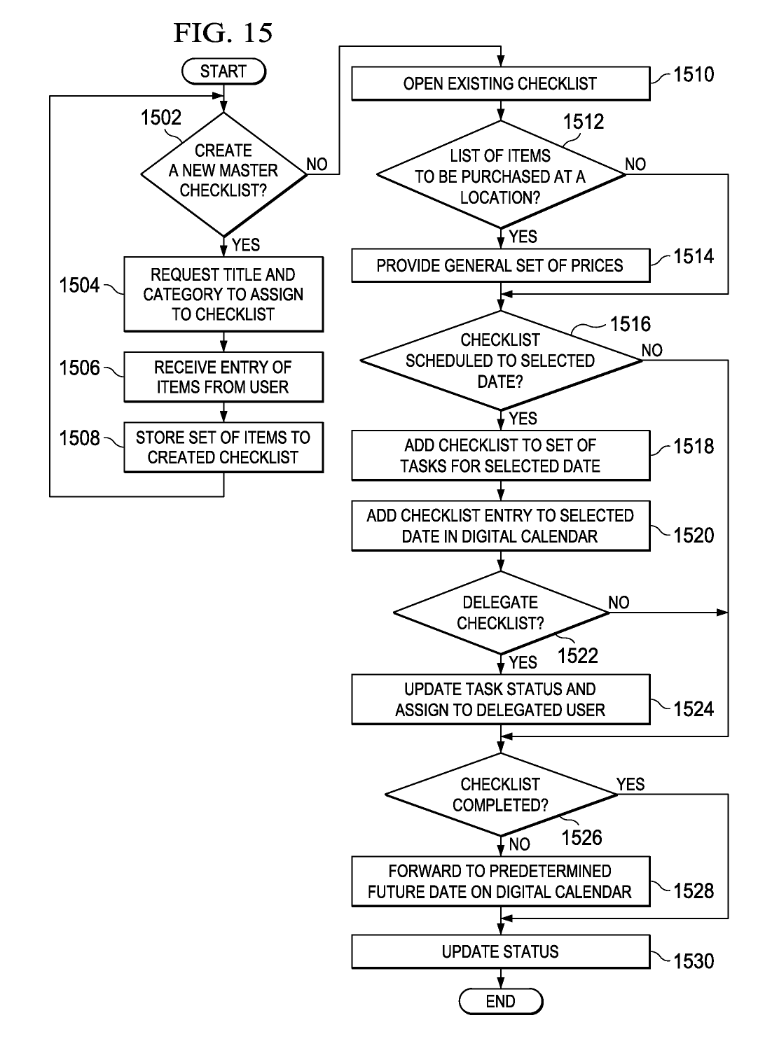

FIG. 15 is a flowchart of a process for a lists modular component in accordance with one embodiment. The method described in FIG. 14 is in accordance with an exemplary method for using a lists module associated with a daily digital planner 100 in FIG. 1 and daily digital planner 204 in FIG. 2. The lists module is a module for creating, maintaining, and tracking master checklists, custom checklists, and task lists, such as lists 218 in FIG. 2.

The process begins by determining whether a user is creating a new master list (step 1502). If yes, the checklist module requests a title and category to assign to the new master list (step 1504). An entry of items is received from user (step 1506). The set of items from the user is stored to the newly created master checklist (step 1508) with the process returning to step 1502 thereafter. The set of items are stored along with the created master checklist in daily digital planner on a computing device, such as computing device 202.

If the user is not creating a new master list at step 1502, an existing checklist is opened (step 1510). The existing checklist may correlate to any type of items that may be included on a checklist, such as, without limitation, grocery store items, office supplies, party planning supplies, drugstore and pharmacy supplies, and/or health stores.

A determination is made as to whether the list of items for the existing checklist is to be purchased at a location (step 1512). If yes, a general set of prices for the items at the location is provided (step 1514).

A determination is made as to whether the checklist is scheduled to a selected date (step 1518). If yes, the checklist is added to a set of tasks scheduled for the selected date (step 1520) to form a scheduled task list. A checklist entry is added to the selected date in the digital calendar 1520).

A determination is made as to whether to delegate the checklist to another user (step 1522) if yes, the task status is updated to show the checklist delegated to another user and the checklist is assigned to the delegated user (step 1524).

If the checklist is not delegated at step 1522 or the checklist is not scheduled to a selected date at step 1516, a determination is made as to whether the checklist is completed (step 1526) by the user. If no, the checklist is forwarded to a predetermined future date on the digital calendar (step 1528). The status of the task is updated to show the checklist is forwarded to another date (step 1530) with the process terminating thereafter.

Returning now to step 1526, if the checklist is complete at step 1526, the process updates the task status to show the checklist task is completed (step 1530) with the process terminating thereafter.

In another embodiment, the user may select an alternative location at step 1518. In this embodiment, if the user selects an alternate location other than the original one provided for obtaining the items associated with the checklist, then the checklist modular component queries the internet for an alternate location. The checklist modular component then presents the prices from the alternate location to the user. The process may then continue on at step 1518 enabling the user to schedule and/or delegate the checklist.

The daily digital planner described above has numerous benefits unavailable in currently available alternatives on the market. The daily digital planner as presented is integrated to include necessary and useful components that work together to assemble data that is relevant to a user and assists the user in increasing his or her productivity. Furthermore, the daily digital planner assists a user to not just accomplish tasks, but accomplish a series of tasks to achieve his or her goals.

In one aspect, the daily digital planner provides for a calendar, a journal, and a checklist. The daily digital planner organizes data relevant to a user, including providing a checklist and also a set of tasks to associate with a master calendar. Further, a module for a user's contacts and expenses are provided as part of the daily digital planner.

In one aspect of the daily digital planner, a module is presented to the user for storing pertinent goals and priorities of the user. Then, the module provides for a series of tasks to be associated with the achievement of said goals and priorities. The daily digital planner allows for various components to be shared with other users who also have access to the daily digital planner and are in a network connected to a primary user of the daily digital planner.

### B. Computing and Network Environment

Turning now to FIG. 16, a pictorial illustration of is a pictorial illustration depicting an embodiment of a network environment is shown in accordance with an illustrative embodiment in accordance with one embodiment.

FIG. 16 discloses a pictorial illustration depicting an embodiment of a network environment in accordance with an illustrative embodiment. FIG. 16 depicts a possible operating environment as well as associated system components (e.g., hardware elements) in connection with the methods and systems described herein. Referring to FIG. 16, an embodiment of a network environment 1600 is depicted.

In brief overview, the network environment 1600 includes one or more client devices, 1602, 1604, and 1606. Client devices 1602-1606 include a pictorial illustration of a Personal Computer (PC), Laptop, Tablet, and smart phone device. Clients 1602-1606 (also generally referred to as local machine(s), client(s), client node(s), client machine(s), client computer(s), client device(s), endpoint(s), or endpoint node(s)) in communication with one or more servers 1616-1618 (also generally referred to as server(s), node, or remote machine(s)) via one or more network(s) 1608. In some embodiments, a client, such as 1602, has the capacity to function as both a client node seeking access to resources provided by a server and as a server providing access to hosted resources for other clients 1602-1606.

Firewall 1610 is an application firewall and/or a hardware firewall between network 1608 and servers 1614-1618. Load balancer 1612 distributes workloads associated with clients 1602-1606 across multiple computing resources, such as servers 1614-1618.

Although FIG. 16 shows a network 1608 between the clients 1602-1606 and the servers 1614-1618, the clients 1602-1606 and the servers 1616-1618 may be on the same network 1608. The network 1608 can be a local-area network (LAN), such as a company Intranet, a metropolitan area network (MAN), or a wide area network (WAN), such as the Internet or the World Wide Web.

In some embodiments, there are multiple networks between the clients 1602-1606 and the servers 1616-1618. In one of these embodiments, network 1608 may include both a private network and a public network. Network 1608 may be a private network or a public network.

The network 1608 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 1608 may comprise a wireless link, such as an infrared channel or satellite band. The topology of the network 1608 may be a bus, star, or ring network topology. The network 1608 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped servers 1616-1618. In one of these embodiments, the logical group of servers may be referred to as a server farm or a machine farm. In another of these embodiments, the servers 1616-1618 may be geographically dispersed. In other embodiments, a machine farm may be administered as a single entity. In still other embodiments, the machine farm includes a plurality of machine farms. The servers 1616-1618 within each machine farm can be heterogeneous—one or more of the servers 1616-1618 or machines 1616-1618 can operate according to one type of operating system platform (for example purposes only, WINDOWS NT), while one or more of the other servers 1616-1618 can operate on or according to another type of operating system platform (e.g., Unix or Linux).

In one embodiment, servers 1616-1618 in the machine farm may be stored in high-density rack systems, along with associated storage systems, and located in an enterprise data center. In this embodiment, consolidating the servers 1616-1618 in this way may improve system manageability, data security, the physical security of the system, and system performance by locating servers 1616-1618 and high performance storage systems on localized high performance networks. Centralizing the servers 1616-1618 and storage systems and coupling them with advanced system management tools allows more efficient use of server resources.

The servers 1616-1618 of each machine farm do not need to be physically proximate to another server 1616-1618 in the same machine farm 38. Thus, the group of servers 1616-1618 logically grouped as a machine farm may be interconnected using a wide-area network (WAN) connection or a metropolitan-area network (MAN) connection. For example, a machine farm may include servers 1616-1618 physically located in different continents or different regions of a continent, country, state, city, campus, or room. Data transmission speeds between servers 1616-1618 in the machine farm can be increased if the servers 1616-1618 are connected using a local-area network (LAN) connection or some form of direct connection. Additionally, a heterogeneous machine farm may include one or more servers 1616-1618 operating according to a type of operating system, while one or more other servers 1616-1618 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the VirtualServer or virtual PC hypervisors provided by Microsoft or others.

Management of the machine farm may be de-centralized. For example, one or more servers 1616-1618 may comprise components, subsystems and modules to support one or more management services for the machine farm. In one of these embodiments, one or more servers 1616-1618 provide functionality for management of dynamic data, including techniques for handling failover, data replication, and increasing the robustness of the machine farm. Each server 1616-1618 may communicate with a persistent store and, in some embodiments, with a dynamic store.

Server 1616-1618 may be a file server, application server, web server, proxy server, appliance, network appliance, gateway, gateway, gateway server, virtualization server, deployment server, SSL VPN server, or firewall. In one embodiment, the server 1616-1618 may be referred to as a remote machine or a node. In another embodiment, a plurality of nodes 290 may be in the path between any two communicating servers.

The client(s) 1602-1606 and server 1616-1618 may be deployed as and/or executed on any type and form of computing device, such as a computer, network device or appliance capable of communicating on any type and form of network and performing the operations described herein.

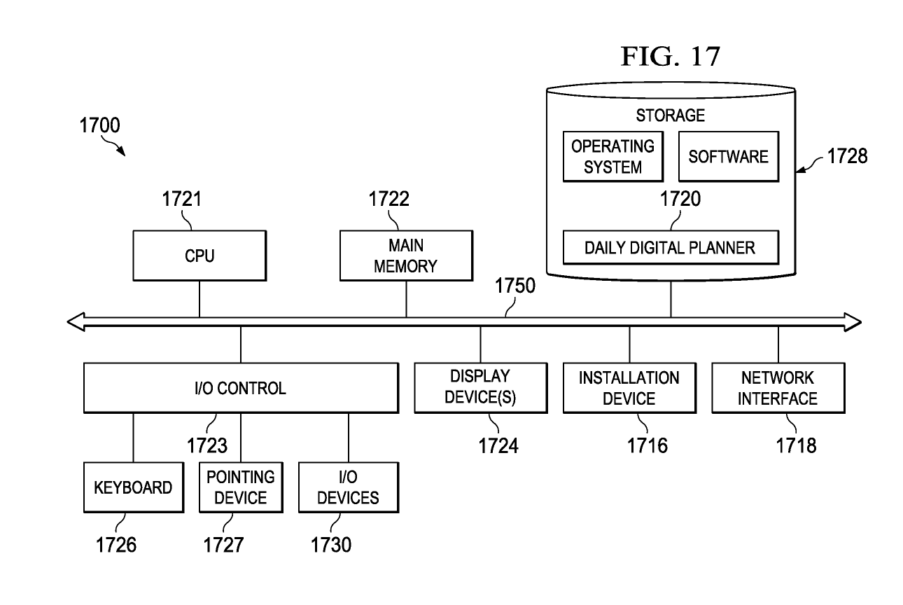

FIG. 17 is a pictorial illustration of a computing device 1700 useful for practicing an embodiment of a client or a server. Computing device 1700 includes a central processing unit (CPU) 1721, and a main memory unit 1722. Computing device 1700 may include a storage device 1728, an installation device 1716, and a network interface 1718, an I/O controller 1723, display device 1724, a keyboard 1726 and a pointing device 1727, such as a mouse. The storage device 1728 may include, without limitation, an operating system, software, and the daily digital planner 1720. Each computing device 1700 may also include additional optional elements, such as a memory port, a bridge, one or more input/output devices 1730, and a cache memory in communication with the central processing unit 1721.

The central processing unit 1721 is any logic circuitry that responds to and processes instructions fetched from the main memory unit 1722. In many embodiments, the central processing unit 1721 is provided by a microprocessor unit. The computing device 1700 may be based on any of these processors, or any other processor capable of operating as described herein.

Main memory unit 1722 may be one or more memory chips capable of storing data and allowing any storage location to be directly accessed by the CPU 1721, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 1722 may be based on any of the above described memory chips, or any other available memory chips capable of operating as described herein. The CPU 1721 communicates with main memory 1722 via a system bus. CPU 1721 communicates directly with main memory 1722 via a memory port. For example, the main memory 1722 may be DRDRAM.

Main processor 1721 may communicates directly with a cache memory via a secondary bus, sometimes referred to as a backside bus. In other embodiments, the main processor 1721 communicates with cache memory using the system bus. The cache memory typically has a faster response time than main memory 1722 and is typically provided by SRAM, BSRAM, or EDRAM. The processor 1721 communicates with various I/O devices 1730 via a local system bus. Various buses may be used to connect the central processing unit 1721 to any of the I/O devices 1730, including a VESA VL bus, an ISA bus, an EISA bus, a MicroChannel Architecture (MCA) bus, a PCI bus, a PCI-X bus, a PCI-Express bus, or a NuBus. For embodiments in which the I/O device 1730 is a video display, the processor 1721 may use an Advanced Graphics Port (AGP) to communicate with the display.

In another embodiment of a computer 1700, the main processor 1721 communicates directly with I/O device 1730 via HYPERTRANSPORT, RAPIDIO, or INFINIBAND communications technology. Another embodiment in which local busses and direct communication are mixed: the processor 1721 communicates with I/O device 1730 using a local interconnect bus while communicating with I/O device 1730 directly.

A wide variety of I/O devices 1730 may be present in the computing device 1700. Input devices include keyboards, mice, trackpads, trackballs, microphones, dials, drawing tablets, touch, finger gestures, and/or body gestures. Output devices include video displays, speakers, inkjet printers, laser printers, and dye-sublimation printers. The I/O devices may be controlled by an I/O controller 1723 as shown in FIG. 17. The I/O controller may control one or more I/O devices such as a keyboard 1726 and a pointing device 1727, e.g., a mouse or optical pen. Furthermore, an I/O device may also provide storage and/or an installation medium 1716 for the computing device 1700. In still other embodiments, the computing device 1700 may provide USB connections (not shown) to receive handheld USB storage devices such as USB Flash Drive line of devices.

The computing device 1700 may support any suitable installation device 1716, such as a floppy disk drive for receiving floppy disks such as 3.5-inch, 5.25-inch disks or ZIP disks, a CD-ROM drive, a CD-R/RW drive, a DVD-ROM drive, Blu-ray DVD drive, a flash memory drive, tape drives of various formats, USB device, hard-drive or any other device suitable for installing software and programs. The computing device 1700 may further comprise a storage device, such as one or more hard disk drives or redundant arrays of independent disks, for storing an operating system and other related software, and for storing application software programs such as any program related to the software 1720 for the daily digital planner. Optionally, any of the installation devices 1716 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 1700 may include a network interface 1718 to interface to the network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11B, IEEE 802.11g, CDMA, GSM, WiMax and direct asynchronous connections). In one embodiment, the computing device 1700 communicates with other computing devices 1700 via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 1718 may comprise a built-in network adapter, network interface card, PCMCIA network card, card bus network adapter, wireless network adapter, USB network adapter, modem or any other device suitable for interfacing the computing device 1700 to any type of network capable of communication and performing the operations described herein.

In some embodiments, the computing device 1700 may comprise or be connected to multiple display devices 1724, which each may be of the same or different type and/or form. As such, any of the I/O devices 1730 and/or the I/O controller 1723 may comprise any type and/or form of suitable hardware, software, or combination of hardware and software to support, enable or provide for the connection and use of multiple display devices 1724a-1724n by the computing device 1700. For example, the computing device 1700 may include any type and/or form of video adapter, video card, driver, and/or library to interface, communicate, connect or otherwise use the display devices 1724. In one embodiment, a video adapter may comprise multiple connectors to interface to multiple display devices 1724. In other embodiments, the computing device 1700 may include multiple video adapters, with each video adapter connected to one or more of the display devices 1724. In some embodiments, any portion of the operating system of the computing device 1700 may be configured for using multiple displays 1724. In other embodiments, one or more of the display devices 1724 may be provided by one or more other computing devices, for example, via a network. These embodiments may include any type of software designed and constructed to use another computer's display device as a second display device 1724 for the computing device 1700. One ordinarily skilled in the art will recognize and appreciate the various ways and embodiments that a computing device 1700 may be configured to have multiple display devices 1724.

In further embodiments, an I/O device 1730 may be a bridge between the system bus 1750 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 1700 of the sort depicted in FIG. 17 typically operates under the control of operating systems, which control scheduling of tasks and access to system resources. The computing device 1700 can be running any operating system available to one of ordinary skill such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, WINDOWS VISTA, WINDOWS 7, and WINDOWS 8.1, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 1700 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 1700 has sufficient processor power and memory capacity to perform the operations described herein. For example, the computer system 1700 may comprise a device of the IPOD, IPHONE, IPAD, or APPLE TV family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED, NINTENDO REVOLUTION, or a NINTENDO WII device manufactured by Nintendo Co., Ltd., of Kyoto, Japan, an XBOX, XBOX 360, or XBOX KINECT device manufactured by the Microsoft Corporation of Redmond, Wash.

In some embodiments, the computing device 1700 may have different processors, operating systems, and input devices consistent with the device. For example, in one embodiment, the computing device 1700 may be any type of smart phone belonging to a user. An example of smart phone includes, but is not limited to, any generation of IPHONE smart phone, which is manufactured by Apple, Inc. In some of these embodiments, the IPHONE is operated under the control of the iOS operating system and includes systems and methods for touch input device. In other embodiments, the computing device may be a smart phone operated under the control of the GOOGLE ANDROID operating system. The user may utilize any type of smart phone and necessary operating system to actively utilize the smart phone.

In other embodiments the computing device 1700 is a mobile device, such as a JAVA-enabled cellular telephone or personal digital assistant (PDA). In some embodiments, the computing device 1700 is a mobile device manufactured by Nokia of Finland, or by Sony Ericsson Mobile Communications AB of Lund, Sweden.

In still other embodiments, the computing device 1700 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 1700 is a smart phone, Pocket PC, Pocket PC Phone, or other handheld mobile device supporting Microsoft Windows Mobile Software. Moreover, the computing device 1700 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 1700 is a digital audio player, and may be any type of digital audio player known to one of ordinary skill in the art. In one of these embodiments, the computing device 1700 is a digital audio player such as the Apple IPOD, IPOD Touch, and IPOD NANO lines of devices, manufactured by Apple Computer of Cupertino, Calif. In another of these embodiments, the digital audio player may function as both a portable media player and as a mass storage device.

In some embodiments, the communications device includes a combination of devices, such as a mobile phone combined with a digital audio player or portable media player. In one of these embodiments, the communications device is a smart phone, for example, an iPhone manufactured by Apple Computer, or a Blackberry device, manufactured by Research In Motion Limited. In yet another embodiment, the communications device is a laptop or desktop computer equipped with a web browser and a microphone and speaker system, such as a telephony headset. In these embodiments, the communications devices are web-enabled and can receive and initiate phone calls. In other embodiments, the communications device is a Motorola RAZR or Motorola ROKR line of combination digital audio players and mobile phones.

In some embodiments, the status of one or more machines in the network is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

The different illustrative embodiments recognize and take into account that it may be desirable to schedule tasks in association with goals. Further, the different illustrative embodiments recognize the usefulness of a task prioritization system. Furthermore, the various integrated modular components as previously described work cohesively to provide a user with many useful features and functions contained in the daily digital planner. These modular components may include, but are not limited to, a Vault modular component for storing personal information, an Expenses modular component for inputting and tracking a user's Expenses, a Journal for including text and images frequently used by a user, an E-Card modular component which stores an image of cards belonging to a user and the accompanying information located on the cards.

Thus, the illustrative embodiments provide a computer implemented method, data processing system, and computer program product for managing and prioritizing information and data in a daily digital planner located on a computing device associated with a user. The daily digital planner is configured to receive data to associate with a set of modular components to be implemented in the daily digital planner. The daily digital planner further comprises a goal oriented modular component. The user is queried for a set of goals to be recorded in the goal oriented modular component. A set of tasks are assigned for achieving one or more of the goals in the set of goals. The set of tasks are associated with a prioritization system, wherein the prioritization system lists the set of tasks to a user in a hierarchy. The set of tasks are coordinated for scheduling with a digital calendar component included in the daily digital planner.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for an integrated daily digital planner, the system comprising:
a computing device, wherein the computing device generates a homepage for a daily digital planner, wherein the daily digital planner comprises a plurality of modular components; and a display device associated with the computing device, wherein the display device displays the homepage for the daily digital planner, wherein the homepage comprises a calendar pane, a notes pane, a tasks pane, and a time and expenses pane, wherein the daily digital planner further comprises:
a calendar modular component, wherein the calendar modular component displays a first selected date and a set of entries associated with the first selected date within the calendar pane, wherein each entry in the set of entries indicates an event or task scheduled to occur on the selected date;
a notes modular component of the daily digital planner, wherein the notes modular component displays a set of notes created on the selected date and a set of attachments associated with the set of notes in the daily notes pane and shared with users on a substantially real-time basis;
a tasks modular component, wherein the tasks modular component displays a set of tasks associated with the selected date in the tasks pane, wherein the tasks modular component further comprises:
a set of task status indicators, wherein a task status indicator indicates a status of each task in a current set of tasks scheduled to occur on the current date, wherein a task status comprises an in progress task status, a deleted task status, a delegated task status, an assigned task status, a forwarded task status, and a no action task status.

2. The system of claim 1 further comprising:
an expenses modular component, wherein the expenses modular component generates a create expenses field within the time and expenses pane on the homepage, and wherein the expenses modular component adds a new time and expense entry to a set of time and expenses entries associated with the current date in the digital calendar, wherein a time and expense entry in the set of time and expense entries is an expenses entry, a miles entry, or a time entry created by the user in the time and expenses pane on the homepage, and wherein the set of time and expenses entries further comprises a set of attachments associated with the set of time and expense entries.

3. The system of claim 2 further comprising:
a search results report generated by the expenses modular component, wherein the search results report comprises a set of time and expenses entries associated with a user selected period of time, wherein the set of time and expenses entries in the search results report comprises time and expenses entries filtered in accordance with a user selected set of filters, wherein the user selected set of filters comprises at least one of a project, client, amount, category, time only, expenses only, miles only, data only, and consolidated attachments only.

4. The system of claim 1 further comprising:
a lists modular component of the daily digital planner, wherein the lists module comprises a set of master lists, wherein each master list in the set of master lists comprises a template set of items, and wherein the lists modular component generates a create master lists pane, wherein the lists modular component receives a title and a set of items entered into the create master lists pane by the user; and wherein the lists modular component assigns the new master list title and the set of items to a new master checklist, and wherein the lists modular component stores the set of items and the title for the new master list in a set of master lists associated with the lists modular component.

5. The system of claim 1 further comprising:
a lists modular component of the daily digital planner, wherein the lists modular component receives a selection of an existing master checklist comprising a set of items and a title for a new customized checklist, wherein the lists modular component adds the customized checklist to the set of tasks; in response to the user scheduling the checklist to a selected date, the lists modular component adds a task list entry to the selected date in the digital calendar; and
the tasks modular component, wherein the tasks modular component updates a task status
responsive to a user selection to delegate the task list to another user or forward the task list to another date.

6. The system of claim 1 further comprising:
a goals modular component of the daily digital planner, wherein the goals modular component comprises a set of goals, wherein each goal in the set of goals comprises a set of sub-goals, wherein each sub-goal in the set of sub-goals comprises a set of goal related tasks, and wherein each task in the set of goal related tasks comprises a task status indicating a progress of the user toward accomplishing the goal associated with the set of goal related tasks.

7. The system of claim 1 further comprising:
a leadership modular component of the daily digital planner, wherein the leadership module comprises a set of leadership values, wherein each leadership value in the set of leadership values comprises a set of leadership related tasks and a ranking, wherein the ranking is a management ranking or a user provided self-evaluation ranking, wherein each task in the set of leadership related tasks is a task associated with demonstrating a leadership value associated with the task, and wherein the ranking identifies how well the user demonstrated a particular leadership value.

8. The system of claim 1 further comprising:
a journal modular component, wherein the journal modular component comprises a set of journal categories, wherein each category in the set of journal categories comprises a set of journal titles, and wherein each journal title in the set of journal titles comprises a journal entry.

9. The system of claim 1 further comprising:
an e-Card modular component of the daily digital planner, wherein the e-Card modular component comprises a set of e-Cards, and wherein an e-Card in the set of e-Cards comprises an image of a card and a set of descriptive data associated with the card, wherein the set of descriptive data comprises at least one of a title of the e-Card, an expiration date, a reminder request, and a card number.

10. A computer implemented method for an integrated daily digital planner, the computer implemented method comprising:
generating a homepage of a daily digital planner on a display device of a computing device, wherein the homepage comprises a calendar pane, a task pane, a daily notes pane, and a create notes pane, and a time and expenses pane;
displaying a first selected date and a first set of entries on a digital calendar within the calendar pane, wherein each entry in the set of entries indicates an event or task scheduled to occur on the first selected date;
displaying a first set of notes created on the first selected date in the daily notes pane;
displaying a first set of tasks associated with the first selected date in the tasks pane;
responsive to the user selecting a different date in the digital calendar to form a second selected date, displaying a second set of notes created on the second selected date in the daily notes pane and a second set of tasks scheduled to occur on the second selected date in the tasks pane;
responsive to a user creating a new note in the create notes field, adding the new note to a current set of notes associated with a current date in the digital calendar;
responsive to the user creating a new time and expense entry in a create expenses field within the expenses pane on the homepage, adding the new time and expense entry to the set of time and expenses entries associated with the current date in the digital calendar, wherein a time and expense entry is an expense entry, a time entry, or a miles entry created by the user in the time and expenses pane on the homepage;
tracking a status of each task in a current set of tasks scheduled to occur on the current date, wherein a task status comprises an in progress task status, a deleted task status, a delegated task status, an assigned task status, a forwarded task status, and a no action task status;
identifying a set of incomplete tasks in the current set of tasks at a predetermined time, wherein an incomplete task is a task having an in progress task status, a delegated task status, or a no action task status; and
forwarding the set of incomplete tasks to a forwarded set of tasks scheduled to occur on predetermined future date on the digital calendar.

11. The computer implemented method of claim 10 further comprising:
performing a search of all time and expenses entries associated with a given period of time; and
generating a search results report including all time and expense entries associated with the given period of time, wherein the search results report comprises time and expenses entries filtered in accordance with a user selected set of filters, wherein the user selected set of filters comprises at least one of a project, client(s), amount, category, time only, expenses only, miles only, data only, and consolidated attachments only.

12. The computer implemented method of claim 10 further comprising:
receiving a title for a new master list;
receiving a set of items for the new master list; and
storing the set of items to the new master list in a set of master lists associated with a lists component.

13. The computer implemented method of claim 10 further comprising:
receiving a selection of an existing checklist comprising a set of items;
responsive to a user scheduling the checklist to a selected date, adding the checklist to a set of tasks for the selected date associated with the tasks modular component and adding a task list entry to the selected date in the digital calendar;
responsive to a user selection to delegate the task list, updating a task status indicating the task list is delegated to another user and assigning the task list to the delegated user.

14. The computer implemented method of claim 10 further comprising:
responsive to a goals modular component receiving an entry of a set of goals created by the user, prompting the user to create a set of tasks associated with each goal in the set of goals, wherein each task in the set of tasks is a task intended to assist the user in achieving a goal in the set of goals;
responsive to receiving a user created set of tasks for a given goal in a set of goals, tracking a status of the each task in the set of tasks;
responsive to receiving a scheduled date for a given task in the set of tasks, adding the task to the set of tasks associated with the scheduled date and adding an entry into digital calendar for the scheduled date identifying the given task; and
generating a progress report for each goal in the set of goals.

15. The computer implemented method of claim 10 further comprising:
receiving a set of leadership values selected by the user;
assigning a set of tasks to each value in the set of leadership values; and
generating a self-evaluation summary based on a user created self-evaluation ranking for each value in the set of leadership values.

16. The computer implemented method of claim 11 further comprising:
receiving a user selected journal category;
assigning the user selected journal category to a user created journal entry; and
saving the journal entry in the journal category to a journal modular component associated with the daily digital planner.

17. The computer implemented method of claim 10 further comprising:
receiving an image of a physical card;
assigning a set of descriptive data to the image of the physical card to create a new e-Card, wherein the set of descriptive data comprises at least one of a title of the e-Card, an expiration date, a reminder request, and a card number; and
storing the new e-Card in a set of e-Cards associated with an e-Card modular component of the daily digital planner.

18. The computer implemented method of claim 10 further comprising:
cross-platform synchronizing the digital calendar of the daily digital planner with a set of other calendaring applications, wherein the set of other calendaring applications is associated with a plurality of different computer software platforms; and
sharing a group calendar view associated with the digital calendar of the daily digital planner with each user in a set of networked users.

19. A system for an integrated daily digital planner, the system comprising:
a computing device, wherein the computing device generates a homepage for a daily digital planner, wherein the daily digital planner comprises a plurality of modular components;
a display device associated with the computing device, wherein the display device displays the homepage for the daily digital planner, wherein the homepage comprises a calendar pane, a notes pane, a tasks pane, and a time and expenses pane; and
a network, wherein the computing device is connected to the network, wherein the daily digital planner further comprises:
a calendar modular component, wherein the calendar modular component comprises a digital calendar, a set of entries in the digital calendar, and a group calendar view, wherein each entry in the set of entries indicates an event or task scheduled to occur on a selected date, wherein the group calendar view is accessible to a group of networked users associated with a set of remote computing devices, wherein entries in the digital calendar marked private by the user are excluded from the group calendar view, and wherein the calendar modular component synchronizes the digital calendar with a set of other calendar applications associated with the user, wherein the integrated digital planner updates the set of entries in the digital calendar with a second set of entries received from the set of other calendar applications;
a notes modular component of the first daily digital planner, wherein the notes modular component displays a set of notes created on the selected date in the daily notes pane, and wherein the set of notes comprises a set of shared notes, wherein a set of networked users is granted access to view the set of shared notes within the set of notes, wherein the second user has access to view the set of shared notes; and
a tasks modular component of the first daily digital planner, wherein the tasks modular component displays a set of tasks associated with the selected date in the tasks pane.

20. The system of claim 19 wherein the set of tasks comprises a set of assigned tasks and a set of delegated tasks, wherein a task in the set of assigned tasks is a task assigned to the first user by a user in a group of networked users, and wherein a delegated task in the set of delegated tasks is a task delegated to another user in a set of networked users.
